(19) United States
(12) Patent Application Publication
(10) Pub. No.: US 2002/0149617 A1
(43) Pub. Date: Oct. 17, 2002

(54) Remote collaboration technology design and methodology

(76) Inventor: David F. Becker, Houston, TX (US)

Correspondence Address: David M. Ostfeld, Chamberlain, Hrdlicka, White, Williams & Martin, Suite 1400, 1200 Smith Street, Houston, TX, 77002, US

(21) Appl. No.: 10/109,189

(22) Filed: Mar. 28, 2002

Related U.S. Application Data
(60) Provisional application No. 60/280,008, filed on Mar. 30, 2001.

(51) Int. Cl. H04N 7/18; G09G 5/00

(52) U.S. Cl. 345/751; 345/734; 345/753; 725/80

(57) ABSTRACT

A method for collaborating remotely that incorporates the use of high-resolution computer imagery, or any other source of high-resolution video, is provided. The method provides for converting high-resolution video or analog RGB computer video into for example, High-Definition Television (HDTV) signals or keep the RGB computer signal in its original format but in digital form. These signals are then compressed, encoded and transmitted over a broadband communication network. At a remote site, the signals are decompressed, decoded and displayed on an HDTV-capable display device. Additionally, the HDTV signals can be reformatted back into their original high-resolution video format or analog RGB computer signals for viewing on an appropriate video display device. If the signals are kept in their original RGB format but in digital form, this last step would not be required, only a conversion back to analog form would be needed. Broadcast and interactivity can be provided to multiple sites, and include multiple computer and/or video screens. Local and remote mouse and keyboard control of the computer imagery or other high-resolution video source are also provided in the method. Additional interactivity is provided by incorporating video marking devices into the system. Collaboration is further supported by the inclusion of audio/video teleconferencing methods and technologies, both NTSC(PAL)-based, and HDTV-based. Access to a number of various computers and high-resolution video sources is provided via a matrix video/keyboard/mouse/serial switching system. Security is provided via encryption and the control systems employed. Records of the collaborative session are provided by the inclusion of HDTV video-recording devices. Ergonomic support is provided by a master control system that configures all devices for specific forms of remote collaboration.

### CROSS-REFERENCE TO RELATED APPLICATIONS

This application claims priority of U.S. Patent Application Serial No. 60/280,008 filed Mar. 30, 2001, entitled Collaboration/Communication Technology Design and Methodology for which this application is a continuation in part.

### FIELD OF THE INVENTION

The present invention relates to a Remote Collaboration design and method. More particularly, “Remote Collaboration” means that one or more persons or groups of people are not in the same physical location as another person(s) or group(s), but are still able to fully interact, not only amongst each other. More particularly, the present invention relates to Remote Collaboration between various persons and groups wherein the collaboration utilizes computer-generated information and graphics displays with other high-resolution video sources, and with each other, in a real-time mode.

### BACKGROUND OF THE INVENTION

The Need for Collaboration

In today's age of ever increasing technology, specialization is becoming increasingly prevalent as it takes a single person a number of years to become fully familiar with a particular aspect of a technology and the appropriate application of specific knowledge related to that technology. Because of specialization, organizations employ team-based work groups whose members provide the diversity of knowledge and experience required for the appropriate analysis of data and information. This is done to gain the greatest understanding in the quickest time of the vast amounts of data and information that the computing and other information technologies of today provide.

Successful productivity resulting from effective teamwork has elicited great attention in the development of new processes, procedures and methods, both human and technological that fully exploit the value of teamwork and collaboration amongst people. Human developmental factors include various seminars and ongoing education on teams and teamwork, understanding the personalities of people, how to conduct brainstorming sessions, etc. Technological factors have included things as simple as workrooms, conference tables and chalk boards. They have also included more 20^{th}-century based technologies such as electronic white boards, teleconferencing, videoconferencing, and internet-based meeting/conferencing hardware and software. They have also included the most advanced 21^{st}-century computer technologies such as visualization workrooms, virtual reality environments, environmental simulators, and so on.

Today's organizations employ a vast array of computing technologies to support their information processing and decision making needs. Indeed, most scientific, manufacturing, simulation, finance and other design and analysis tasks used by today's businesses depend intrinsically on computer-based software and hardware.

Any effective collaboration technology has to support the users' rich set of existing interaction skills.

In the case of video teleconferencing, studies have found that a video channel adds or improves the ability to show understanding, forecast responses, give non-verbal information, enhance verbal descriptions, and manage pauses and express attitudes. The findings suggest that video is particularly useful for handling conflict and other interaction-intense activities. However, the advantages of video depend critically on the instantaneous transmission of the audio and video signals, and on the resolution of the video image. To read facial expressions, one must be able to see and recognize the little nuances that define them. Additionally, when compared with face-to-face interaction, it can be difficult in teleconferencing interactions to notice peripheral cues, control the floor, have side conversations, and point to things or manipulate real-world objects. To fully enable rich interactions, video needs to be integrated with other technologies that allow natural collaborative behaviors to occur across shared remote spaces.

Current Collaboration Technologies

### Two Basic Methods

There are two major means of providing computer imagery to remote locations for purposes of collaboration known in the art. There are also various blends of the first two of these methods.

The first method, which will be referred to as the “Duplicate Resources” method, as its name implies requires duplicate resources at all collaboration locations. Therefore, if a high-end visualization machine, like a Silicon Graphics Onyx, is required to provide the computer images, then all sites need to have the same or an equivalent machine. Also, all the data, which may easily be on the order of terabytes of information, must be stored at all locations. Additionally, the software being used has to be licensed, installed, maintained and of the same version level at all locations. If a number of collaboration sites are involved, the cost of providing all those duplicate hardware and software resources can become excessive. Also, the “Duplicate Resources” method requires significant lead time to organize all the data and make sure everything is the same at all locations before a collaboration session can begin. As such, spur-of-the moment, just-in-time collaboration is not possible. Because of the preparation time required, this method also causes significant delays when data are changed or added to.

The second method, referred to as “Send Graphics Commands,” necessitates that only the graphics commands provided to the graphics hardware in the local computer also be sent to the remote locations, where it is processed and display using appropriate graphics hardware at the remote locations. The graphics commands are high-level commands that do not carry a lot of data, and therefore they can be sent over low-bandwidth communications networks. Because of the low bandwidth required, these methods of remote collaboration are called “Thin Client” methods. The “Thin Client” method alleviates a good portion of the resource duplication inherent in the “Duplicate Resources” method, but still requires that similar graphics hardware be available at all collaboration locations. For the remote sites, sometimes the hardware can be provided on lower-cost computers, but other times the same computer resources used to generate the graphics are still required to process the graphics at the remote location(s). These methods of remote collaboration usually are not designed very well for multipoint collaboration, but rather for allowing one person to work with another person.

### Examples of the First Two Methods

With the needs for Remote Collaboration discussed above, a mechanism of allowing realtime human and computer collaboration amongst people at remote locations is a growing necessity. Technologies such as Microsoft's NetMeeting™, Lotus' Sametime™ and Silicon Graphic's SGIMeeting™ have been developed to address some of these needs. These and similar products, to one degree or another, use proprietary software to allow people to communicate and share computer screen information with each other. They can work on documents together, share an electronic white board, and even in some cases, share a software application. The drawback of these software approaches include in whole or in part, the need to have similar compute power at both locations, the need to have data stored at both locations, the need to have the software being used, both for collaboration and otherwise, licensed and installed at both locations, etc. In addition, these methods are not easily expandable to multiple remote sites. For each site, all the necessary resources need to be available locally. These applications use the “Duplicate Resources” Method.

Other collaboration markets that rely on proprietary technology are the Application Service Providers (ASPs). These companies make software available to their customers such that the ASP provider handles most of the number crunching, storage and provisioning of the data and databases, and conducting archive, backup and other software, hardware, and IT-related tasks. Their client only needs to log into their IT-based services using a simple desktop workstation or PC. Again, in all applications to date, specific software, and sometimes hardware needs to be supplied at the remote client sites. These applications rely more on the “Thin Client” method.

### Additional Limitations of the First Two Methods

Another drawback to the collaboration methods described above is the non-real-time nature of the collaboration. Web cameras can be incorporated into the solution, but the images are often jerky, frames of information are dropped, and the video is of very low resolution. Additionally, there is usually a significant amount of latency involved in seeing the mouse and keyboard commands typed at one site show up at a remote site (on the white board for example). These methods are not unlike talking to someone overseas via a space-borne communications satellite. The delays involved and information dropped significantly decreases the effectiveness of the communication and therefore the collaboration.

Another problem faced by today's collaboration technology is the need to have real-time, full motion, full-resolution computer graphics on the viewing screens at each location. Basic teleconferencing technology can at best send NTSC (640 by 480) or PAL (768 by 576) television resolutions (and usually, about half of the resolution indicated is actually used). However, most computer screens use resolutions of 1280 by 1024 or above. There are technologies available that “down convert” computer resolutions of 1280 by 1024 to NTSC or PAL resolutions; however, too much information is lost in the conversion.

One solution might be to transmit raw screen information digitally. However there is a significant amount of bandwidth required to do so; and the greater the resolution of the screen, the greater the bandwidth that is needed.

Presently there is a need for improving the communication available in a remote collaborative environment. Moreover, there is a need to effectively transport a highly complex, expensive, computer environment from a local location to one or more remote locations without once again incurring the significant cost of creating the environment at the remote location(s). Those skilled in the art will appreciate how the present invention addresses the above and other problems associated with collaborating remotely especially when incorporating high-resolution video.

It is the object of the present invention to view and interact with a signal at both locations without the need for expensive computer processing, numerical and graphical.

### BRIEF SUMMARY OF THE INVENTION

The present invention captures the graphics signals being output from the computer in their raw video format (the format that is sent to the computer monitor for viewing). At this point, all computer processing, numerical and graphical, is complete. Therefore viewing it at a remote location does not require any computer hardware at all. In this method, the raw computer video output is converted to high-definition television, and like any other form of television, can be broadcast and received using the same equipment that television broadcaster use.

In the present invention high-resolution computer imagery is included in the collaborative environment without the need for duplicate computers, software, and the like at the remote location(s). Another aspect of the invention is that real-time, full-motion, teleconferencing and videoconferencing capabilities are an integral part of the solution. These capabilities are also combined with the appropriate control systems such that users at any of the collaboration locations can interact with objects and people at the other locations, by either manual or automatic control. By having control over camera position, angle, and so forth, one can “look around” a remote site as good as or better that if one were seated at that site.

The technology described intrinsically supports simultaneous multiple camera views. By having simple control over real-time video capability and multiple cameras the type of rich interactions amongst collaborators as described above can take place.

### BRIEF DESCRIPTION OF THE DRAWINGS

For further understanding of the nature and objects of the present invention, reference should be had to the following drawings in which like parts are given like reference numerals and wherein:

FIG. 1 is a generalized representation of the system;

FIG. 2 is a more detailed illustration of the system of FIG. 1, showing the individual components involved in providing Remote Collaboration;

FIG. 3 shows the interconnectedness of the pieces of equipment for the system in FIG. 1;

FIGS. 4-A-H show drawings that illustrate the connectivity paths for various signals used to achieve the fully integrated Remote Collaboration capability of the preferred embodiment of the present invention;

FIG. 4-A shows the connections and flows of the RGB signals involved in the system;

FIG. 4-B shows the PS/2 paths that provide keyboard and mouse connectivity;

FIG. 4-C shows the connectivity path for HDTV signals;

FIG. 4-D shows the connectivity of the communications network that links the various sites of the Remote Collaboration session;

FIG. 4-E shows the paths corresponding to the serial signals used to provide pointing and mouse control via the video overlay device;

FIG. 4-F shows the signal paths for NTSC (PAL) video used to provide video conferencing capabilities to the Remote Collaboration session;

FIG. 4-G shows the signal paths for audio/sound information that provides teleconferencing capabilities to the Remote Collaboration session;

FIG. 4-H shows the signal connections for the control system that is used to set-up, initialize, and control the various hardware components used to provide the various Remote Collaboration capabilities;

FIGS. 5-A-E contain the drawings that describe the IP Mouse and Keyboard Device (IPKMD);

FIG. 5-A and FIG. 5-B show how the device of the present invention is connected into the Remote Collaboration system;

FIG. 5-C shows a functional diagram of the IPKMD device;

FIG. 5-D illustrates an example of the front (top) and back (bottom) of the device;

FIG. 5-E shows an example of the input menu used to configure the IPKMD;

FIGS. 6-A-F show the drawings that describe the Low-latency Pointing and Mouse Device (LLPMD);

FIG. 6-A and FIG. 6-B show how the LLPMD is connected in a typical Remote Collaboration session;

FIG. 6-C shows a functional diagram of the LLPMD; Collaboration session;

FIG. 6-C shows a functional diagram of the LLPMD;

FIG. 6-D shows the front (top) and back (bottom) of the LLPMD;

FIG. 6-E and FIG. 6-F show example menus for configuring the LLPMD, connecting various LLPMDs to the Collaboration session, and accessing the pointing, drawing and adaption functions of the LLPMD; and

FIG. 7-A illustrates a combination laser-pointer/video-camera pointing device.

### DESCRIPTION OF THE PREFERRED EMBODIMENT

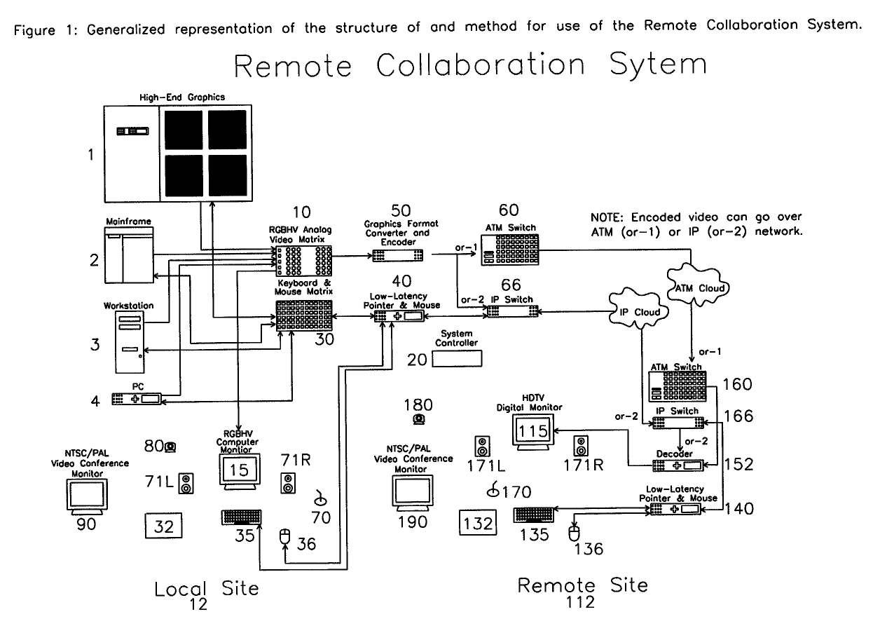

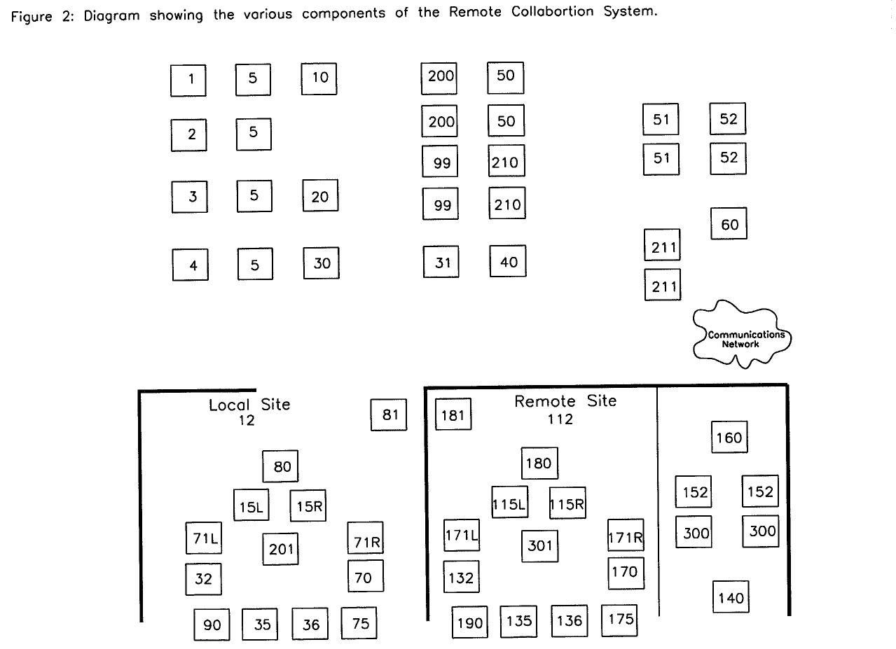

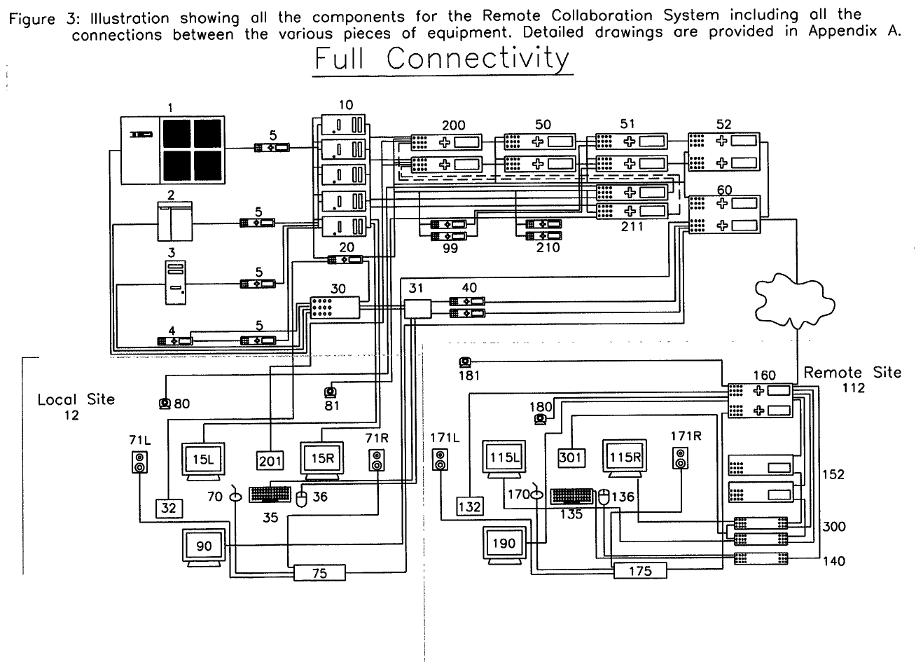

As shown in FIG. 1, computer RGB information is routed from the computer 1, 2, 3, 4 to both a monitor 15R at the local location and also to a graphics format converter and encoder 50. The encoded signals are sent over ATM 60 or the Internet 64 to a decoder 152 at the remote location 112. From there they are converted back and viewed either on an HDTV-capable monitor 115R, or a normal analog-RGB computer monitor. Similarly, keyboard and mouse commands from either the local or remote locations can be routed back to the same computer. A more detailed illustration of the system, showing the individual components involved in providing the Remote Collaboration technology is shown in FIG. 2. FIG. 3 shows how each piece of equipment is connected to the others.

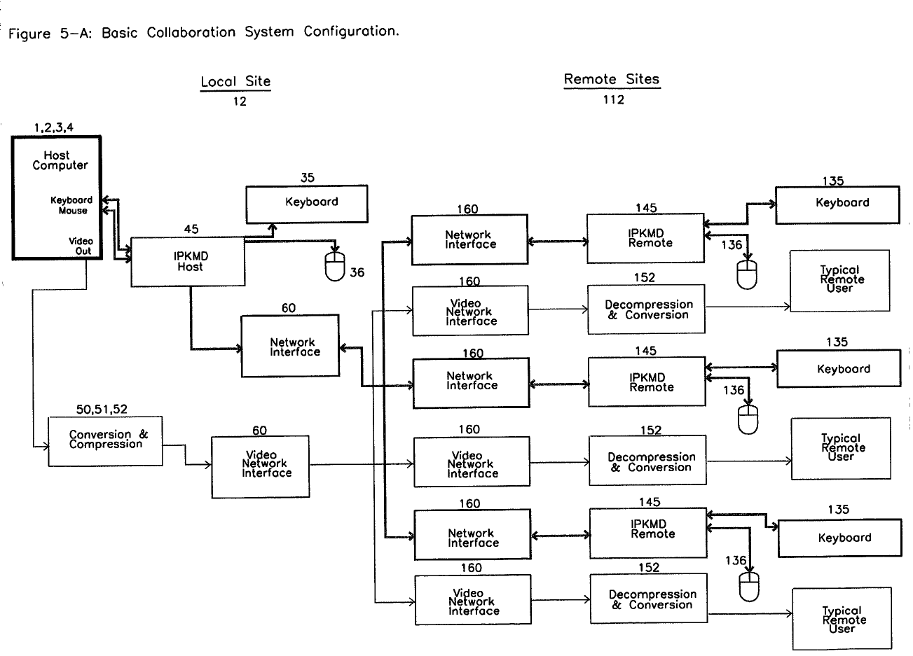

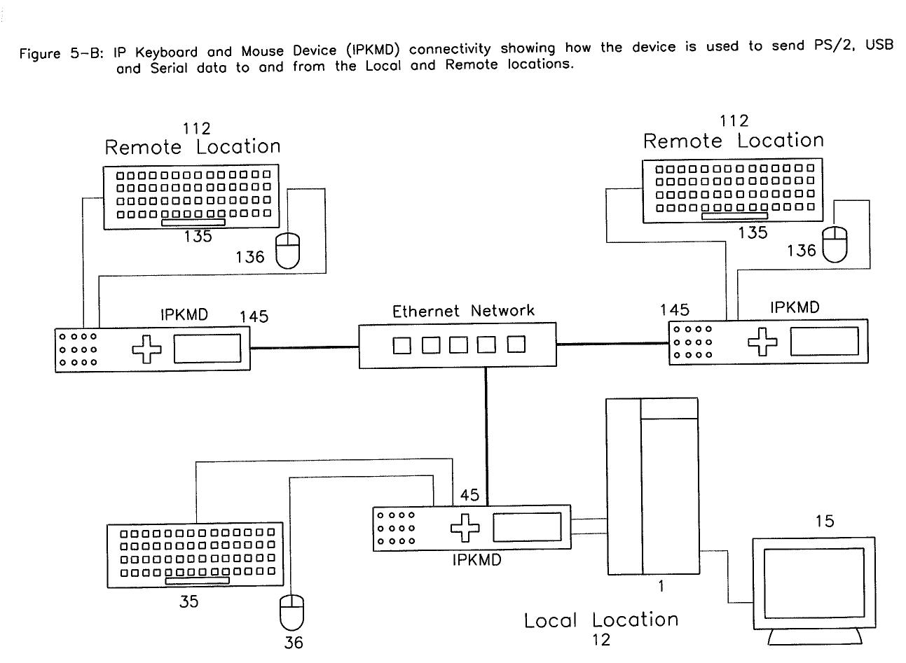

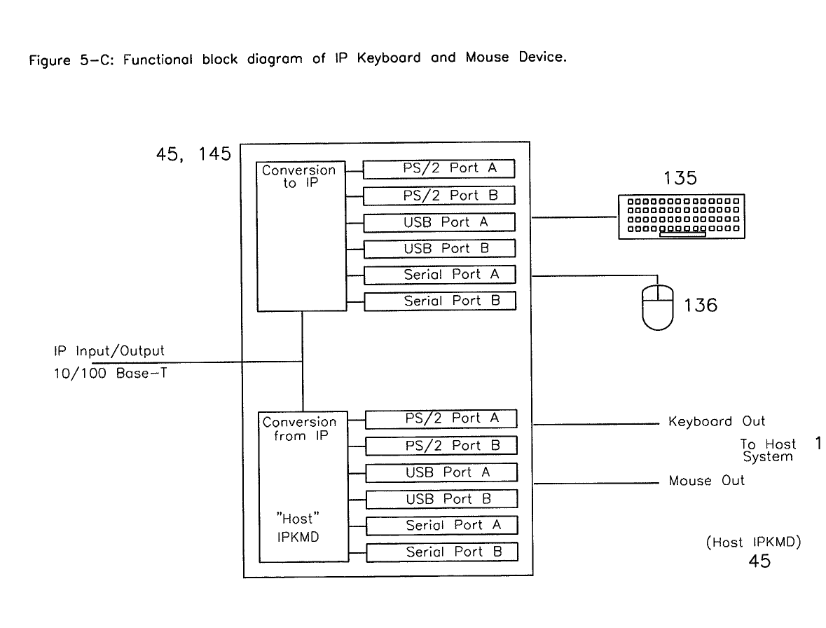

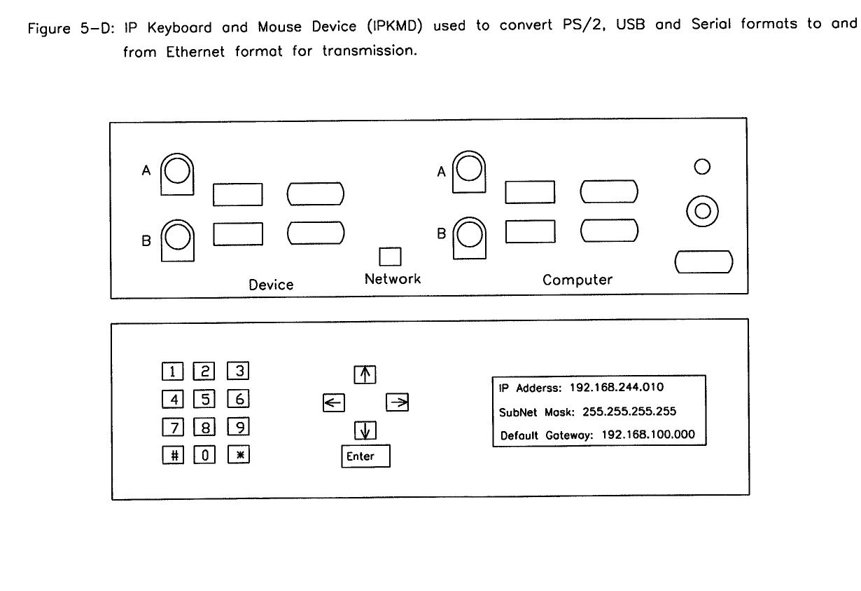

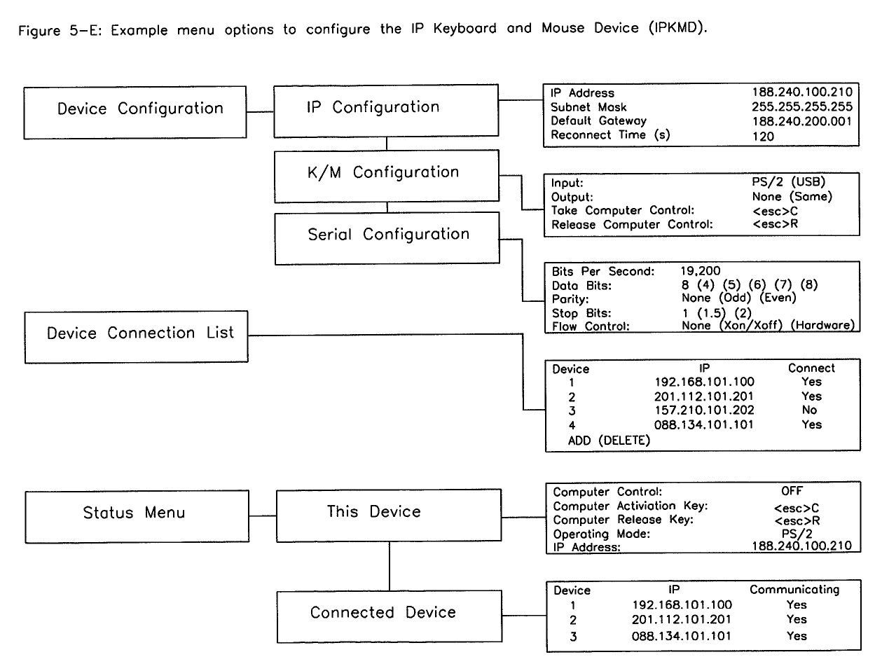

As shown in FIGS. 5-A-E, the IPKMD is used to convert PS/2 and USB mouse and keyboard commands from the remote collaboration locations into Internet packets. The packets are then sent to the IPKMD located where the computer providing the high-resolution imagery is located. The “local” IPKMD converts the packets back into PS/2 or USB commands that are then sent to computer 1, 2, 3, 4.

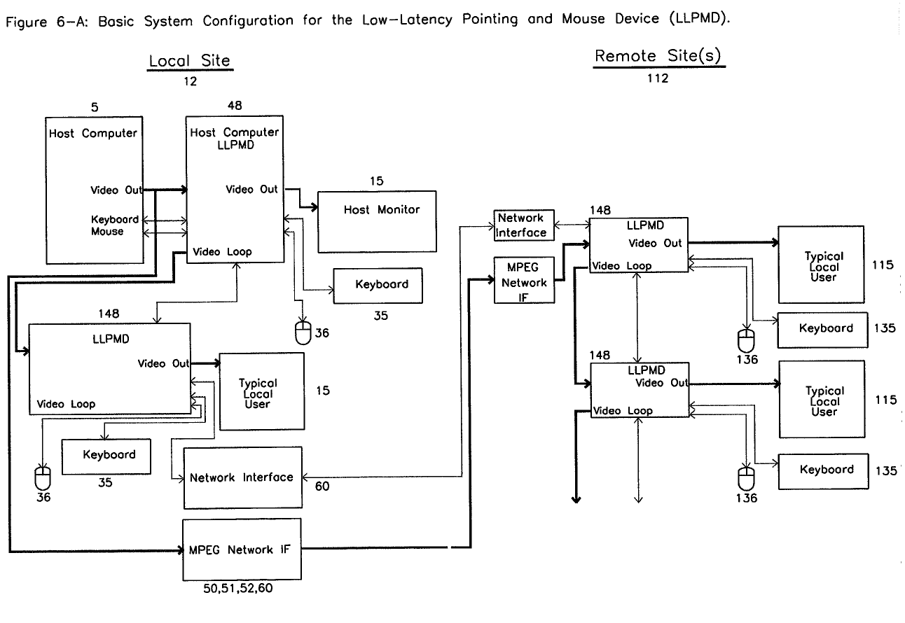

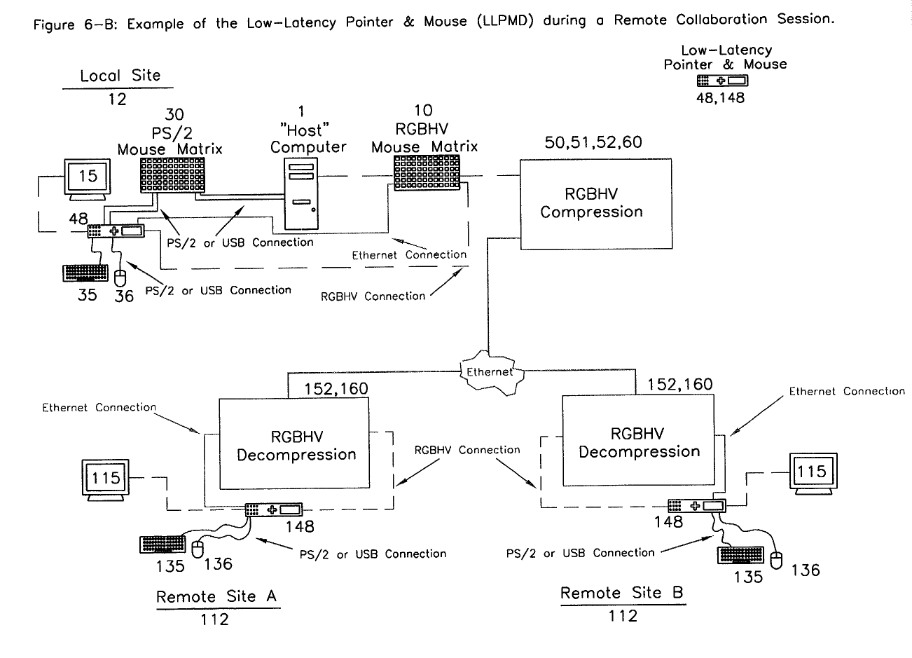

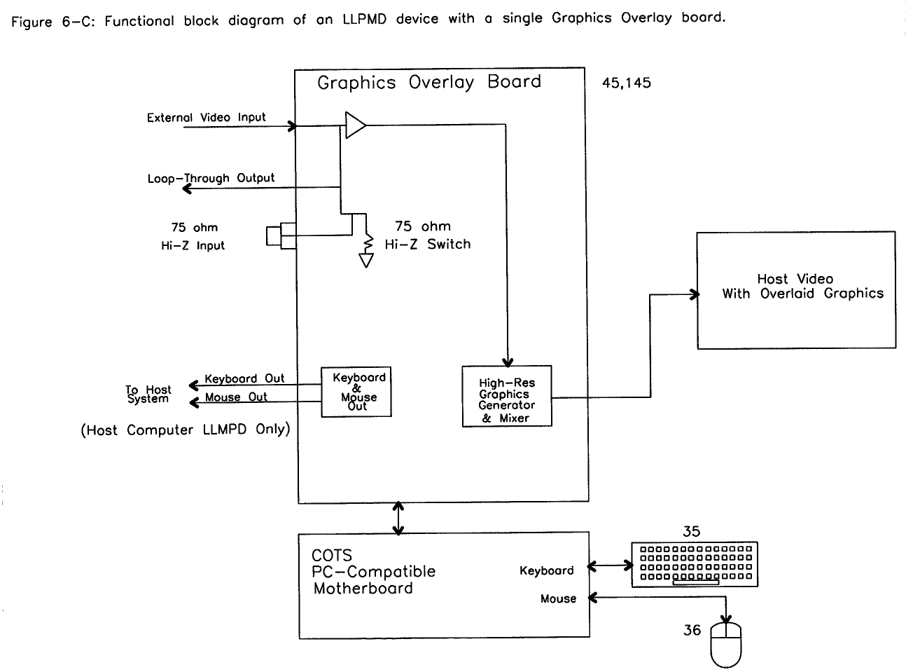

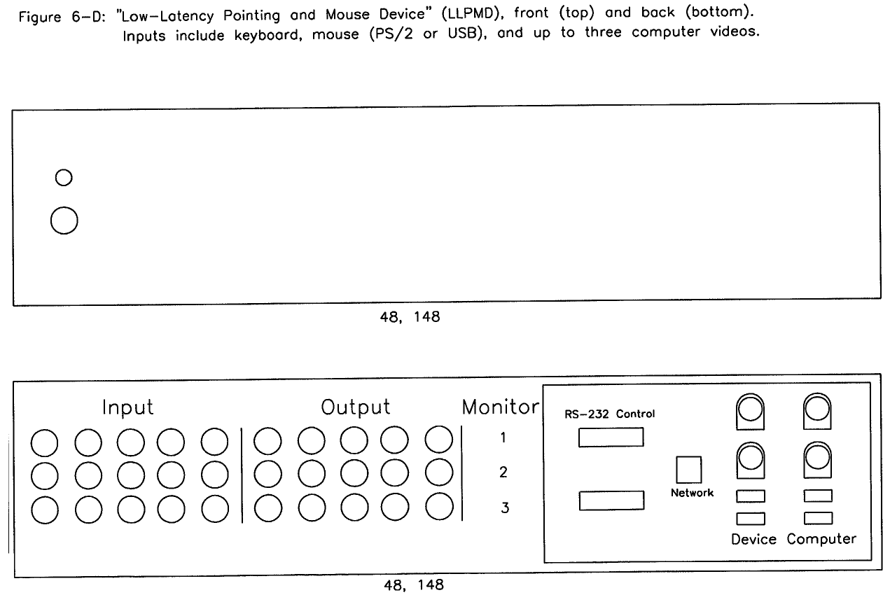

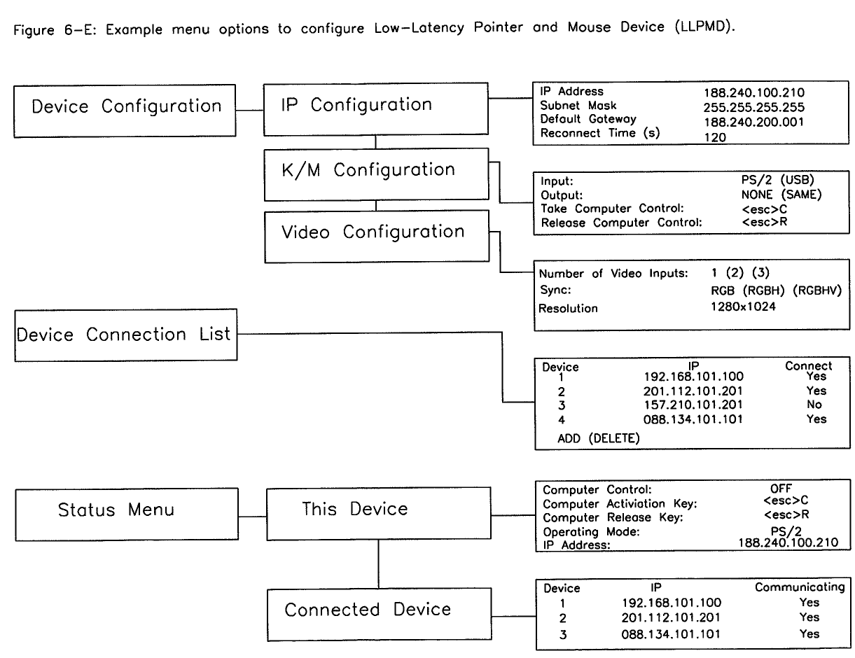

As shown in FIGS. 6-A-F, the LLPMD provides each location in the Remote Collaboration session the ability to have a unique cursor (that they can use for pointing at the imagery) overlain on top of the high-resolution computer imagery. All collaborators see all the various cursors that each uses for pointing. The LLPMD also provides the ability for any person in the collaboration session to take control of the mouse cursor that drives the computer

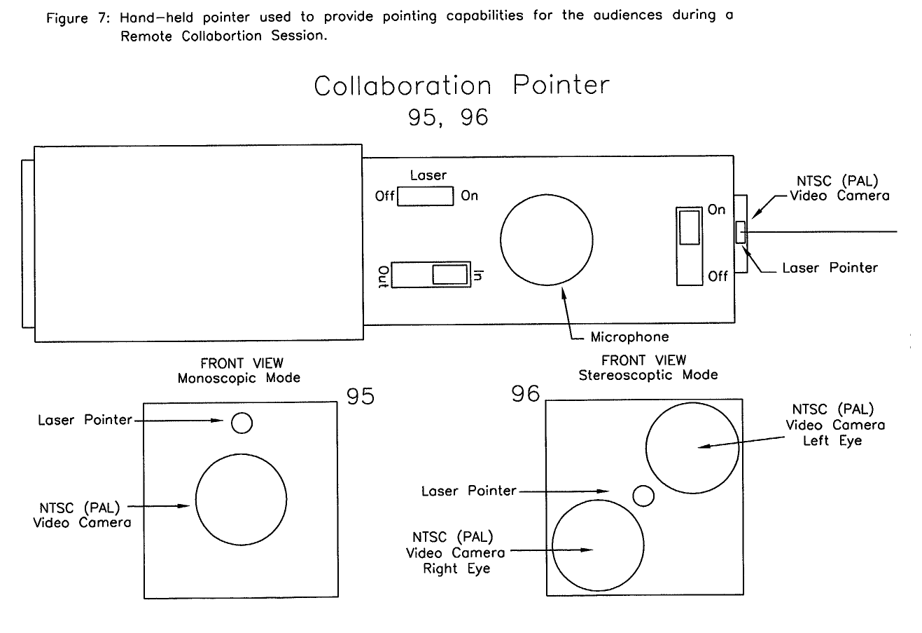

As shown in FIG. 7-A, participants in the audience of the various Remote Collaboration locations can use this device like a standard laser pointer. The video camera is included to allow off-site participants to see what the pointer is focused on by providing a video image of the pointer's “view” via the NTSC(PAL) videoconferencing system.

A schematic representation of how the technology works is provided in FIG. 3. Any type of computer source (e.g., IBM mainframe, SGI Onyx, Sun Workstation, Dell PC, etc.) 1, 2, 3, 4 can be accessed using matrix-switching capability.

An RGB signal leaves the selected computer 1, 2, 3, 4 and goes into the video matrix switch 10. From there it is split in two. One of the signals 11 goes directly to the local site 12 where it is viewed on the local monitor or projector 15L, 15R (for example Sony, ViewSonic, Sharp, Mitsubishi, Digital Projections, Barco, etc.). The other signal gets transmitted to the remote site 90.

The RGB signal being transmitted is processed for efficient transmission. If not already, it is first converted to a digital format, for example to HDTV (other illustrations would include any prescribed and defined digital description of the video image), and compressed, for example using MPEG-2 (other compression means being MPEG-1, MPEG-4, Wavelet-Based, Fourier, etc.). Then compressed digital signal is transmitted using, for example ATM 60 (other means being Internet 64 or any other communications protocol) to a remote location (if there are multiple remote locations, it is transmitted to all of them substantially at the same time using the communication network's broadcasting capabilities). Once at the remote site, the compressed digital signal is decompressed, decoded and viewed, for example, on an HDTV monitor 115L, 115R. Alternatively, the signal can reconverted back to its original RGB analog format and viewed on any normal computer monitor (for example Sony, ViewSonic, Sharp, Mitsubishi, Digital Projections, Barco, etc)

A specially designed “Low-Latency Pointer and Mouse Device” (LLPMD) as described herein is also provided at the local and the remote sites. The Low-Latency Pointer and Mouse Device provides: (a) pointing capabilities so all participants in the collaboration session have an on-screen pointer that all other participants can see; and (b) mouse and keyboard control so that any participant in the collaboration session can control the computer. The LLPMD takes PS/2 and USB keyboard and mouse input. It also takes in and outputs a video source. The output video is the same as the input video, except that it has additional graphics information overlain on it by the LLPMD (such as each collaborator's pointer and their on-screen drawing and annotation). LLPMDs at the various locations communicate information to each other using, for example IP or Internet communications (other communication protocols could be also used). The LLPMD at the “local” location is connected, for example by PS/2 (other means could be USB, serial, etc.) to the computer, so that it can pass the keyboard and mouse commands to the computer from the “remote” LLPMDs.

A System Controller 12 and touch panels at the local and remote locations provide control over the entire system.

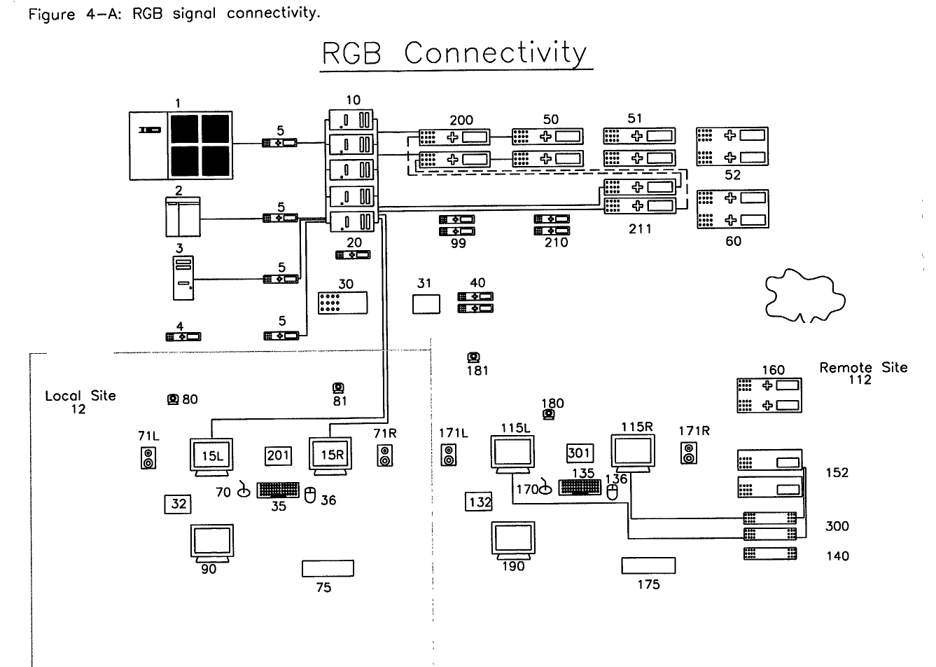

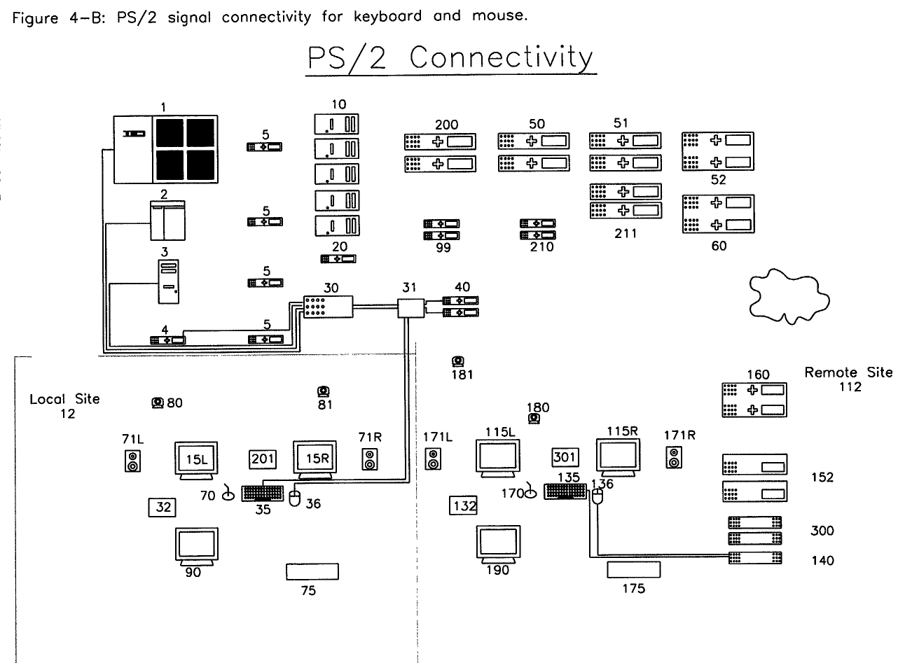

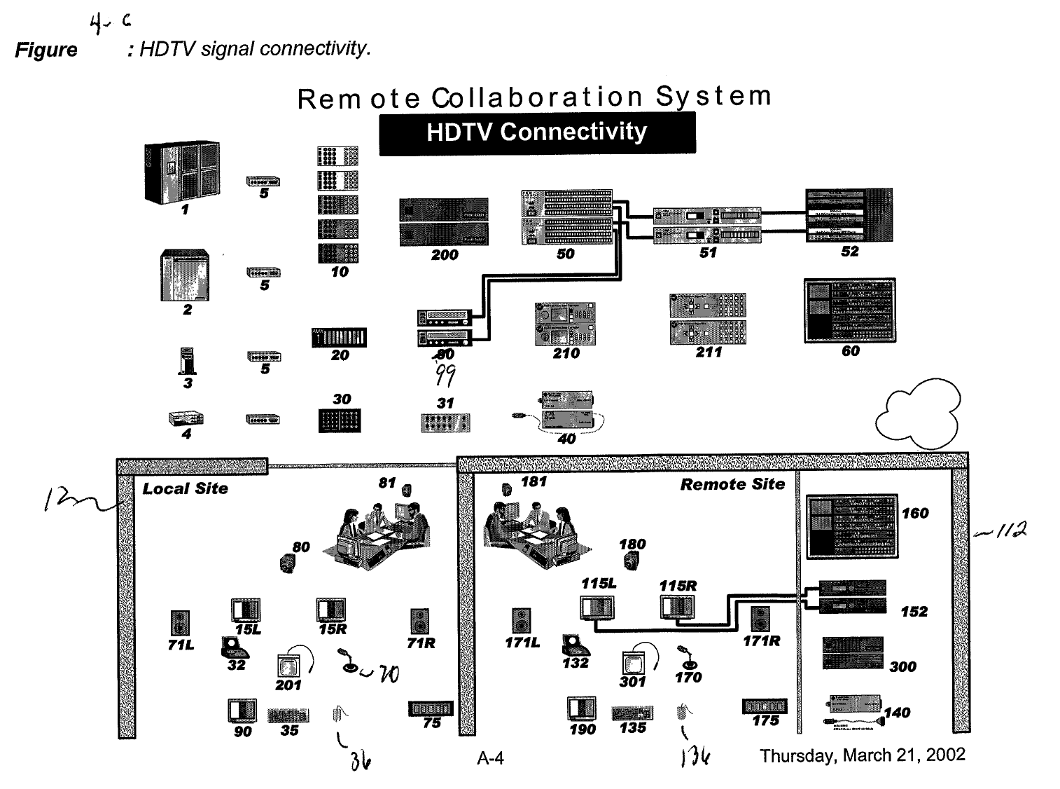

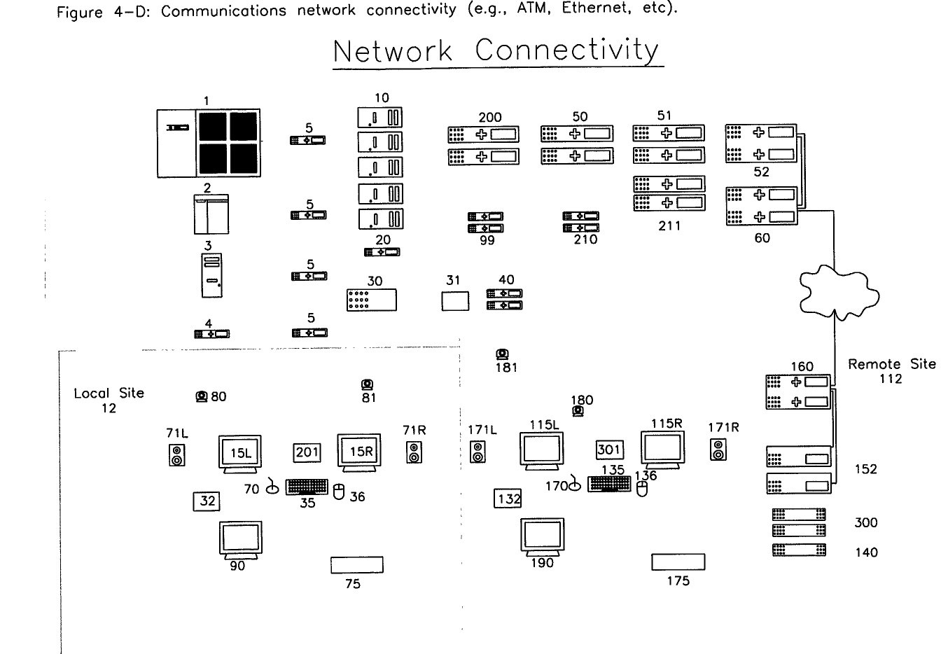

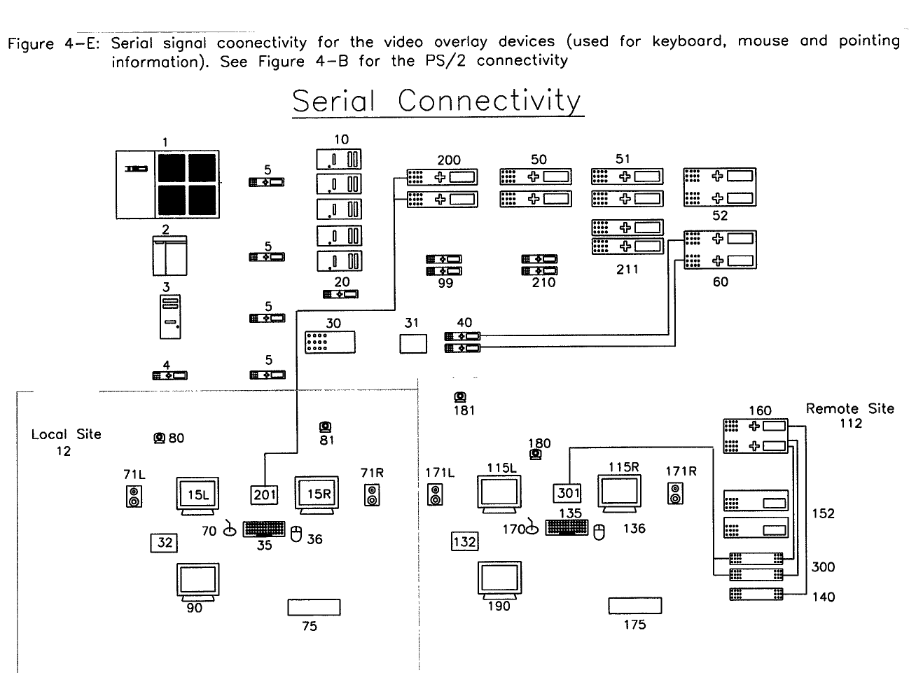

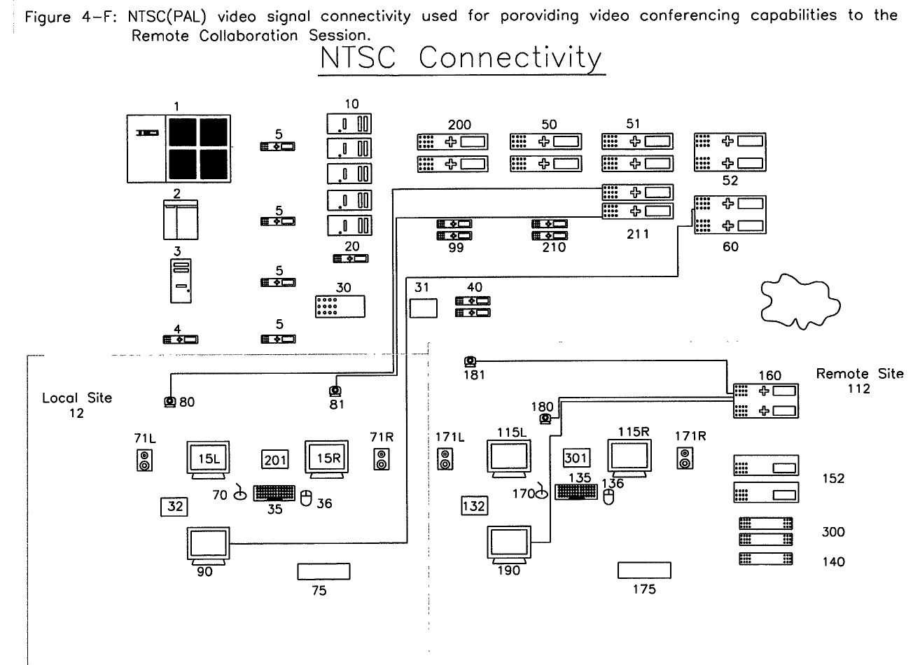

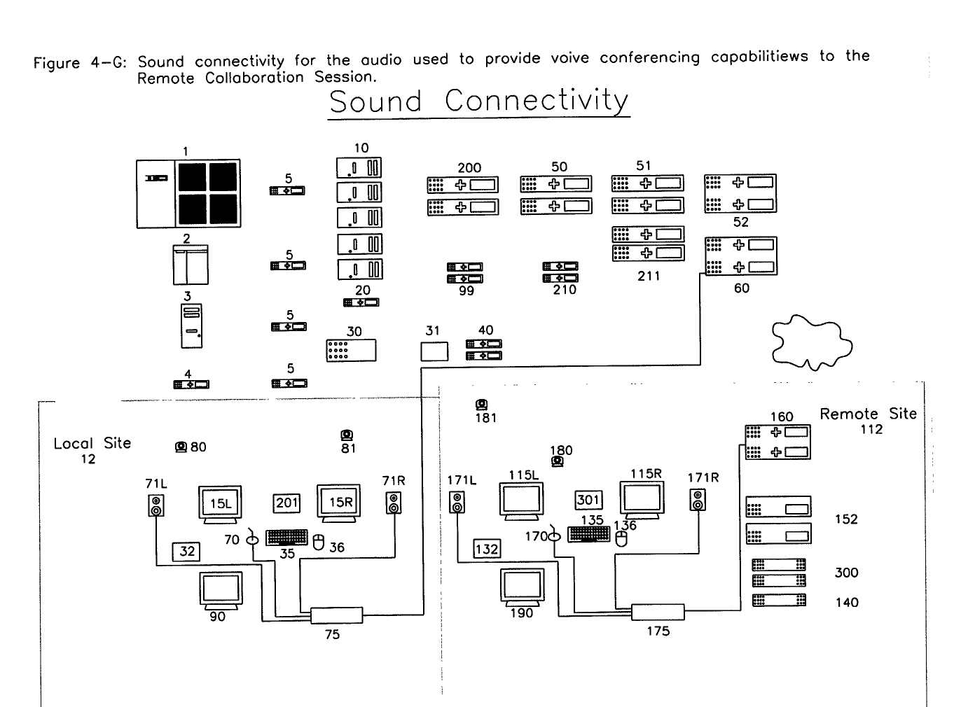

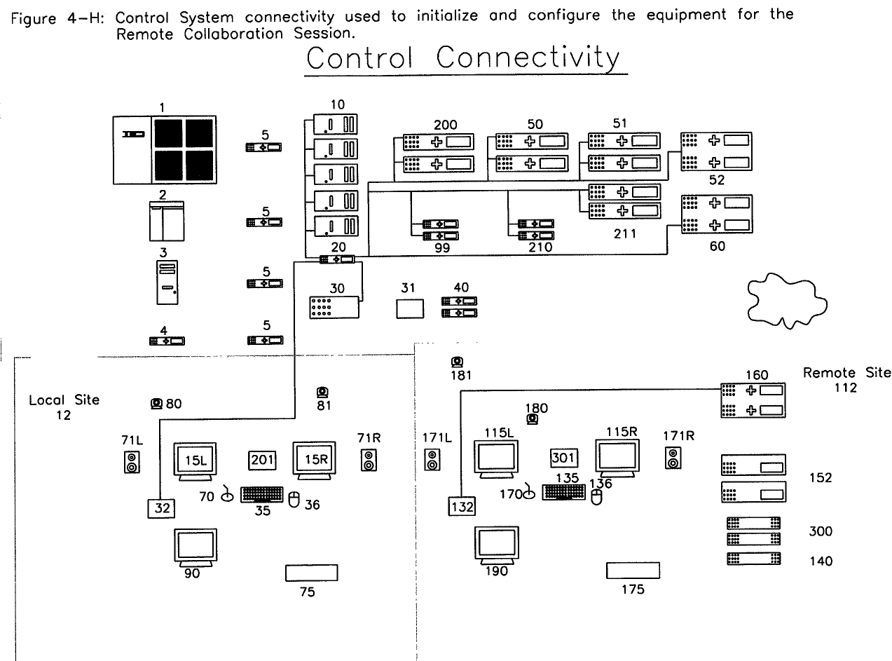

Referring to FIG. 2 and Table 1, Table 1 provides a detailed list describing most of the components in FIG. 2, with an equipment supplier/vendor indicated and model number where appropriate as an illustration. The detailed descriptions are categorized based on how the various components are connected. Each form of connectivity is illustrated in detail using the figures provided in FIG. 4. The connectivity for the whole system is shown in FIG. 3, with FIG. 3 being more detailed.

Computer Video Routed Within the Local Facility

Computers output video is separated into three bands of color, RGB (red, green, and blue), known as component video (since each component of color is output separately). Computers also output signals for both horizontal, H, and vertical, V, synchronization of the video signals. These five computer output signals are known as RGBHV component video.

Referring to FIG. 4-A, the RGBHV video outputs of a computer, such as High-End Visualization machines (1), Mainframe computers (2), Desktop Workstations (3), and PCs (4), are sent into a signal conditioner and amplifier (5), one each for each RGBHV output on each computer source. Many standard types of computers 1, 2, 3, 4 could be used in accord with the present invention (e.g., IBM, SGI, Sun servers, mainframes and workstations, Compaq, Dell, HP Gateway desk-side and laptop PCs, etc.). The signal conditioner 5 is used to boost the RGBHV signals for transmission to the matrix switch 10 and to “normalize” the signals across the various computer sources 1, 2, 3, 4.

The various signal conditioners (5) can then be connected to a video matrix switch (10). The matrix switch 10 allows the video output from a specific computer source to be routed to either one, or a number of screen locations substantially simultaneously. Any location that is wired into the output of the matrix switch 10 will be reachable. By routing the video signals substantially simultaneously to more than one office at the local facilities, people in different offices can view the same computer output at the same time. Additionally, by methods described below, any user in any office can also control the keyboard 35 and mouse 36 commands that are sent to the computer source. In this way, via RGB, keyboard and mouse matrix switches 30, computer-based collaboration is provided throughout the local facility.

As a result of the selection of the matrix switches 10 used in the preferred embodiment of the invention, any of the various computer sources, High-End Visualization machines (1), Mainframe computers (2), Desktop Workstations (3), and PCs (4), can be routed through the system. Note that if only one computer source were available and needed, then the matrix switches 10 would not be required. In the case of multiple sources, any source can be selected. For purposes of discussion herein, a High-End Graphics Computer (1) will be used to describe the system's connectivity. In addition, it will be assumed in the following description that there are two video outputs from the High-End Graphics Computer, a left 115L and right 115R screen containing different information. Again, this condition is set only for purposes of description; the system design can handle one to any number of video outputs from any single, or indeed multiple, computer source(s) of any type.

The computer RGBHV signal coming from the High-End Graphics Computer (1) is conditioned and amplified (5). There would actually be two RGB signal conditioner & amplifier interfaces (5) as there are two video outputs, a left and right screen for screens 115L, 115R. The two conditioned RGBHV signals can then be directed into the matrix switch (10). Note that in this example there are actually five elements comprising the matrix switch (10), one for each of the R, G, B, H, and V signals. However, other forms can be used, such as RGB with composite sync (which would require four video matrix elements), or RGB with sync-on-green (which would only require three video matrix elements). Although more expensive and slightly more complex, five separate signals, R, G, B, H, and V, are preferred. It allows for greater signal integrity.

From the video matrix switch (10) the video signals can be routed to two computer screens (115L, 115R) at the local facility 12 for viewing. Instead of going to two computer monitors 15L, 15R, the signals could also be sent to two projectors. This allows the computer-screen images to be projected onto a large screen. As a result, multiple people sitting in the same room could all simultaneously view the larger images providing for their collaboration. In this way a number of people 81, 181 sitting in a large workroom can all discuss what is being displayed amongst them. In addition, multiple keyboards can be placed on various tables in the workroom, and via keyboard and mouse switching 31 (FIG. 4-b) any person in the room can control the images being presented on the computer/projection screen.

Keyboard and Mouse Control Routed Within the Local Facility

The keyboard and mouse selector switch (31), FIG. 4-B, allows a number of keyboard/mouse stations to be located around the facility or on various tables in a workroom, But only one of those locations can take “active” control over the computer. To accomplish this, the switch 31 has multiple inputs and one output. The one output is sent directly to the computer being controlled, or is routed through a keyboard and mouse matrix switch (30), just like the computer RGB signals, to reach the various computers: High-End Visualization machines (1), Mainframe computers (2), Desktop Workstations (3), and PCs (4). A keyboard escape sequence is used to pass keyboard and mouse control from one person (one input) to another person (another input).

For keyboard and mouse control within the local facility, signals from the devices are sent back to the computer via the following path, FIG. 4-B. Signals from the local keyboard and mouse (35, 36) are connected to the keyboard/mouse switch (31). The signals are then sent to the keyboard/mouse matrix switch (30). The matrix switch (30) then directs the incoming keyboard and mouse commands to the appropriate computer(s), in the case of the example, the High-End Graphics computer (1).

Computer Video Routed Outside the Local Facility

In the description of the computer video routing given so far, the computer video signals have stayed in their original analog, RGBHV, component format. Such signals can be used over short distances around the local facility. However, if the distances exceed 100 meters and is less than 1,000 meters, fiber-optic extenders can be used to extend the video, keyboard and mouse signals. To actually send the keyboard/mouse and video signals over very large distances, such as across town or across the world, another method has to be used, such as the one described herein.

In today's technology, the easiest way to send information over long distances is by converting that information to digital format. Also, if one wants to minimize the amount of bandwidth required to send that information, then one can employ signal compression techniques. The invention provided herein uses both of these technolgies.

In the preferred embodiment of the method, the analog RGBHV signals are converted to serial digital high-definition television, SDI-HDTV, signals such as those used by U.S. broadcasters to provide television viewers with high-definition television. Using standard broadcasting technology these signals can be compressed (encoded) using, for example, an MPEG compression algorithm. The compressed digital signals are transmitted over a broadband communications line. At the receiving location they are decompressed (decoded). Once decoded the transmitted computer information can be viewed on an HDTV-capable display 115L, 115R. Alternatively, the HDTV signal can also be converted back to RGBHV for viewing on an analog computer display device.

Note that the RGBHV signals do not necessarily need to be converted to HDTV format to be encoded. They also do not need to be compressed using an MPEG compression algorithm. These particular steps are taken to allow the implementation to be done using current, off-the-shelf hardware. Alternatively, and more effectively, specific hardware can be designed and built to perform the analog-to-digital (A/D) conversion and encode and compress the RGBHV signals directly; with a complementary piece of hardware being used at the remote site to decompress, decode and digital-to-analog (D/A) convert the signals back to their original RGBHV form.

A nominal computer screen has a resolution of 1280 by 1024 pixels. As described earlier, this computer resolution is well beyond the resolution of normal NTSC or PAL television. However, high-definition television (HDTV) currently supports resolutions up to 1920 by 1080 (interlaced). This is above the 1280 by 1024 nominal computer-screen resolution, and therefore HDTV can be used to “carry” the computer's screen resolution. In one embodiment of the invention, this is done in the following manner.

Referring to FIGS. 4-B-C, the appropriate RGBHV signals from the matrix switch (10) are directed into a signal reformatter (50). The reformatter converts the analog 1280 by 1024, RGBHV component video signal into an analog 1920 by 1080i HDTV signal. From there, the analog HDTV signal is sent into an A/D converter (51). The A/D converter converts the analog HDTV signal into a serial digital stream, SDI, of data. The output from the A/D converter (51) is the SMPTE (Society of Motion Picture and Television Engineers) standard HDTV signal. This is the same signal used by broadcast facilities throughout the United States and other parts of the world that offer HDTV broadcasts. Note that in another embodiment the reformatting and A/D conversion can be done by one piece of equipment, versus the two separate ones described (50, 51).

To transmit all the information contained in a 1920 by 1080i HDTV signal requires a bandwidth of approximately 1.5 Gbits/s. The ability to access such bandwidth, although not impossible by any means, is nonetheless very costly. To decrease the bandwidth required to transmit the signals MPEG compression is used. This technique provides for various compression levels to achieve various bandwidth restrictions. The usual tradeoff is that the more compression, the greater the potential for degradation of picture quality. In the invention as tested to date, compression down to a bandwidth of 12 Mbits/s has been successfully used.

Referring to FIG. 4-C, the SD-HDTV signal coming from the A/D converter (51) is then sent to the MPEG compression device (52) for encoding and compression. The MPEG compression device (52) also reformats the stream of digital data into a format compatible with network transmission protocols. If a different network transmission protocol is required (such as IP over the Ethernet), another device 66 (FIG. 1) could be added that would take the output of the MPEG compression device and reformat it to the necessary communications protocol.

In one embodiment, the encoded HDTV signals from the MPEG compression device (52) are then sent to an ATM computer network switch (60), FIG. 4-D. From there, the information is transmitted across communication lines to a receiving ATM switch 160 at the remote location (90). Again, any form of network communication can be used instead of ATM, one example being Ethernet and TCP/IP.

Referring to FIG. 4-C, from the ATM switch 160 at the remote location the signals are sent into the MPEG decoder device (152). The MPEG decoder device (152) decodes the signals and converts them back into the full bandwidth SMPTE standard digital HDTV signal (this decoder 152 is similar to the digital decoder that is used on a home television that receives HDTV transmissions from cable or satellite providers). From there the signals can be directed into a digital HDTV monitor for viewing (115L, 115R). Alternatively, they can be sent into another device (not shown) that converts the digital HDTV signals back to either analog HDTV or RGBHV signals, which are then viewable on standard analog video displays.

As mentioned above, the example involves transmitting two computer screens worth of information. Therefore, in the figures there are two each of the RGBHV-to-HDTV converter, (50), the A/D converter (51), the MPEG compression device (52), and the MPEG decoding device (152). If needed, two video scaling devices would also be placed after the HDTV decoder (152) to convert the HDTV signals back to RGBHV so the images can be displayed on two computer monitors.

If only one screen were to be transmitted, then only one of each of those components would be required. Similarly, if more than two computer screens worth of information were to be transmitted, then there would be one of each component for each computer screen to be transmitted. Importantly, the system scales quite easily to accommodate as many screens as necessary.

Keyboard and Mouse Control Routed Outside the Local Facility

To provide full collaborative ability, someone at the remote location not only needs to see the computer information being sent, but they also need to be able to interact and control the computer's output . . . just like the people in the workroom at the local facility. This is accomplished by the following.

Signals from the keyboard and mouse at the remote site (135, 136, FIG. 4-B) are sent to a format converter (140). In one embodiment, the converter converts the PS/2 keyboard and mouse signals to serial, RS-232, format. From there, the serial signals are sent to the ATM switch (160), FIG. 4-E. They are then sent across the communications network to the ATM switch 60 at the local site (12), FIG. 4-D. The local ATM switch 60 then separates the serial keyboard and mouse signals out of the communications packets, and sends them to a second format converter (40), FIG. 4-E. The converter (40) reformats the serial signals back to PS/2 signals. The PS/2 signals are then sent to the keyboard/mouse selector switch (31), FIG. 4-B.

If the user(s) at the remote location has activated his or her keyboard by sending the control sequence to the keyboard/mouse selector switch (31), then the keyboard and mouse commands are sent through to the keyboard/mouse matrix switch (30), and from there to the appropriate computer (in the example, computer 1).

For the described embodiment, wherein the keyboard and mouse are sent as serial data, an ATM switch is required that can directly pass low-speed serial commands from one switch to the other.

### Sending Keyboard and Mouse Signals via Internet Protocol

An alternative embodiment uses “IP Keyboard and Mouse Devices” (IPKMDs) specifically designed for the collaboration setup, FIG. 5-A and FIG. 5-B. The specific hardware design of the IPKMDs is given below. The IPKMDs have the capability to send PS/2, USB, and serial data streams from one location to another over an Internet connection. Notably any type of PS/2, USB or serial device can be connected to the IPKMD, not just a keyboard and mouse. Other devices include various haptic devices used in virtual reality simulations, or any number of USB devices, like flash cards, cameras, scanners, printers, etc. In the description and purpose herein, the ability to use the IPKMD for keyboard and mouse control is a primary focus.

As before, if the user at the remote location activates their keyboard by sending the control sequence to the keyboard/mouse selector switch (31), then their keyboard and mouse commands are sent through to the keyboard/mouse matrix switch (30), and from there to the appropriate computer (in the example, FIG. 1, computer 1).

In “Remote” mode, the IPKMD converts PS/2, USB and serial data streams into a single IP data stream. The IP data stream is then sent, for example, over a 100BaseT network. In “Host” mode, the IPKMD converts the IP data back into its constituent PS/2, USB and serial data streams. These data streams are then sent to the computer 1 in their original format. In particular, a keyboard and mouse connected to the IPKMD in “Remote” mode can send its keyboard and mouse input to a second IPKMD in “Host” mode. The “Host” IPKMD, which is connected to a computer, delivers the keyboard and mouse input to that computer.

System Functional Block Diagram

A typical remote collaboration system configured with the IPKMD is illustrated in FIG. 5-A and FIG. 5-B. There is one IPKMD associated with each remote collaboration location and one for the Host Computer; however, all of the IPKMDs are identical. The Host Computer 1 is the source of video being viewed by the participants.

When in “control” mode any IPKMD can control the Host Computer 1. Obviously, only one participant can control the keyboard and mouse input at any given time. Therefore, control is maintained until the currently assigned user relinquishes that control. After control is relinquished, any other collaborator can request control of the Host Computer's keyboard and mouse input. Once control is turned over, the new operator's keyboard and mouse commands are directed to the Host Computer. Note that control always defaults to the IPKMD associated with the Host Computer if no other sites request control. Additionally, the IPKMD 52 associated with the Host Computer 1 can always take control of the mouse and keyboard without a remote user relinquishing it. The Host Computer IPKMD 52 can also enable/disable the functions of other IPKMDs to maintain the security of the host system.

Messages are displayed on the front of the IPKMDs to indicate who controls the Host Computer 1, and to identify all users (IPKMDs) who are participating in the collaboration session.

IPKMD Functional Description

A functional block diagram of an IPKMD device 52, 152 is provided in FIG. 5-C. All units 152 with the exception of the designated Host Computer IPKMD 52 operate in an identical manner. The Host Computer IPKMD 52 operates somewhat differently as this unit must interact with the Host Computer 1 to control the Host Computer's mouse 36 and keyboard 35 operations.

The connection of the IPKMD to the Host Computer 1 must be transparent. The Host Computer's mouse 36 and keyboard 35 plug into the Host Computer IPKMD 52 and cables from the IPKMD 52 are connected to the Host Computer 1 (see FIG. 5-A and FIG. 5-B). This allows the IPKMD 52 to control the Host Computer 1.

When connecting a keyboard and mouse to the IPKMD, they should be of the same connection. So if a PS/2 keyboard is used, a PS/2 mouse should also be used. Alternatively, if a USB keyboard is used, a USB mouse should also be used. The same is true when connecting the IPKMD to the Host Computer.

Physical Specifications

To accomplish the above functionality the IPKMD is built with the following specifications. FIG. 5-D shows the front (top) and back (bottom) of the IPKMD.

The front has a keypad that is used to input numeric values. It also has arrow keys to move around the various setup menus (see below). Finally there is a display to show the menus and summarize the settings. The back of the IPKMD has a pair of PS/2 connections, USB connections, and RS-232 (16550 UART) connections for device input; a second pair of PS/2 connections, USB connections, and RS-232 (16550 UART) connections for output to the Host Computer; and a single 100BaseT Internet connection.

The pair of PS/2, USB and RS-232 Device connections are used to make the physical connection between various input devices such as a keyboard and mouse and the IPKMD.

The two PS/2, USB and RS-232 Computer connections are used to make the connection between the IPKMD and the Host Computer. When connected to a computer, the Computer PS/2 (and USB) ports must also provide the correct signals to indicate to the computer that there is a keyboard and mouse present (powered up).

Menu Description

The IPKMD has a number of menus used to configure the device. A summary of the menus and their options are given in FIG. 5-E.

### Device Configuration

The Device Confiquration Menu allows the IP information, the keyboard and mouse information, and the video information of the specific IPKMD to be configured.

### IP Configuration

Each IPKMD has its own IP address. The address can be set via the front panel or the RS-232 port. The following IP options will be set under the IP Configuration Menu:

IP Address (Default 000.000.000.000)

Subnet Mask (Default 255.255.255.255)

Default Gateway (Default 000.000.000.000)

This will be a non-DHCP device; so it will have a fixed IP address.

There is a Reconnect Time option under the IP Configuration Menu. If one of the IPKMD devices cannot be reached (pinged) upon session startup, it will be dropped from the collaboration session. Attempts will be made to connect to the device every Reconnect Time seconds (Default is 120 seconds—2 minutes).

### K/M Configuration

The KIM Configuration Menu will have both an Input mode indicating whether the mouse and keyboard are being input through the PS/2 or USB ports (Default is PS/2). During initialization, all IPKMDs in the remote collaboration session will be polled to ensure that all have the same Input mode specified. If all are not the same, a message will come up indicating which IP addresses do not have the same settings, with an option to either Ignore or Retry. Retry will re-query the IPKMDs in the session. Presumably before a Retry someone will have correctly set the IPKMD(s) that were not set up properly. If Ignore is selected, the IPKMD corresponding to the indicated IP address will be permanently dropped from the session (i.e., removed from the Device Connection List).

On the Host Computer IPKMD 52 the Output option under the K/M Configuration Menu will be set to “SAME” if the given IPKMD is connected to the Host Computer. For IPKMDs not connected to the Host Computer, this setting should be “NONE” (Default).

The K/M Configuration Menu will have an Take Computer Control Key option which tells the IPKMD which key sequence will act as the signal to take control of the Host Computer's keyboard and mouse (Default is <esc>C). The KIM Configuration Menu will have an Release Computer Control Key option which tells the IPKMD which key sequence will act as the signal to release control of the Host Computer's keyboard and mouse (Default is <esc>R). Upon initialization, the IPKMD that is connected to the Host Computer will be the one that has keyboard and mouse control.

### Serial Configuration

The Serial Configuration Menu will allow full parameterization of the serial connectivity

### Device Connection List

To communicate amongst the other IPKMDs 52, 152 in the remote collaboration session, each device will have to know the IP address of all the other devices. Via the Device Connection List Menu the IP addresses of all IPKMD devices 52, 152 being used in the remote collaboration session can be input. Next to the IP address for each device will be an option to Connect the device to the session (when IP address is first entered the Connect Default is YES). The last Connect setting for any given IP address is saved in memory. If Connect is set to NO, that device will not be included in the remote collaboration session.

### Status Menu

A Status Menu will be provided that lists the local IPKMD's setup information, The “This Device” Menu will show the status of the specific IPKMD. The “Connected Devices” submenu will show the IP addresses of the other IPKMDs and whether or not they are participating in the remote collaboration session.

### Keyboard and Mouse Latency

There is a certain amount of delay, or latency, in seeing the movement of the mouse cursor or the echoing of the keystrokes on the screen at the remote location relative to when the mouse was actually moved or the keyboard actually struck. The latency is not so bothersome when typing on the keyboard, but can become inconvenient as it relates to mouse movement. The latency is due to two effects: (1) the time required for the signals to travel over the communication line (the PS/2, serial or Ethernet signals from the remote location to the local location, and the video signals back from the local location to the remote location), and (2) the time required for compression/decompression (encoding/decoding) of the computer video signal.

To minimize the first of these effects it is desirable to have as short a communication's path as possible. The more that the signals have to travel through various switching networks, or take tortuous routes from the sending to the receiving location, the greater the mouse and keyboard latency will become.

The second of these latency effects, compression, can be addressed by not having to send the video response corresponding to the movement of the mouse through the encoding/decoding equipment. Instead hardware at the remote site, could allow the video response of the mouse movements (i.e., the mouse cursor) to be overlain on the computer image locally. This eliminates the encoding, transmission and decoding of the video response to the mouse movement. Such a design is similar to the video marking capabilities described in “The Low-Latency Pointing and Mouse Device” Section below, and will be discussed there.

Pointing Devices

As described above, due to the transmission path form the local 12 to the remote 90 site(s) there may be, depending on the system construction used, a certain amount of latency in the movement of the mouse across the computer screen. A significant portion of that latency is a result of the MPEG compression of the computer imagery (which occurs within component 52); however testing has shown that most users at the remote location(s) can effectively adapt to the latency. In less than thirty minutes of use, the user learns to anticipate, and therefore compensate for the latency. Nonetheless, the non-instantaneous response does impede the user's effectiveness. Future improvements in compression hardware and algorithms should decrease this latency.

In a collaborative environment, delays in pointing at portions of the screen for purposes of explanation or to highlight a portion of the image can be annoying (similar to the delay encountered when having an overseas phone call that travels via satellite).

### Pointing Using Video Marker Technology

As shown in FIG. 4-E, to provide real-time pointing capability a pair of video marker devices can be used (200 and 300), with corresponding pointing devices such as pointing tablets (201 and 301). The video marking devices are similar to those used in the broadcast industry when an announcer highlights the paths of players in a football or soccer game on the television screen, or when a meteorologists on a news broadcast indicates the motions of various weather features by drawing arrows over the video representation of a weather map. The actual pointing device does not have to be a tablet; for example, normal mice, touch screens and light pens can also be used depending on the situation.

When using a pair of video marking devices (200 and 300), the pointing information is sent to both simultaneously. This serial information is transmitted over the communications network similar to the way the serial mouse and keyboard commands are sent, FIG. 4-E. These are very low bandwidth (low information content) signals, and can be sent without noticeable delay (it is the MPEG compression that causes the delay of the mouse motion, not so much the transmission of the commands). The video markers at both locations receive the serial pointing signals and generate the appropriate characters and markings to overlay on the computer imagery. Since this is done locally at each site, there is no latency introduced by the MPEG compression, and the pointing appears instantaneous on both the local and remote computer imagery.

It is important to note that the video marking devices must allow users at all locations to mark on the computer imagery. For this to be effective, each device must be able to be set to use a different color pointer to distinguish one person from the next. The video marking devices also provide other useful features for collaboration besides pointing, such as drawing and annotating.

### The Low-Latency Pointing and Mousing Device

In lieu of the IPKMD and Video Marking devices described above, the Low-Latency Pointing and Mouse device (LLPMD) is the preferred device to be used during a Remote Collaboration session with computers to allow participants at all locations to interact with a high-resolution computer image that is being viewed during the session. It has two basic functions pointing and mousing.

Pointing Mode

In pointing mode the LLPMD allows each remote collaboration location to have its own pointer.

When presentations are given at a normal meeting (e.g., all participants in the same room) and a display is being used (e.g., projector, white board, etc.), each participant can point at the display using a pointing device like a laser pointer or by getting up and using their finger. In doing so they bring other people's attention to the particular portion of the display that they are focusing on at the time.

A pointing device is also required during remote collaboration sessions when people are using high-resolution computer imagery. The LLPMD provides this function. It allows each location to have its own unique pointer, and allows all locations to see the pointing movements and input from all other locations. The cursor for each location can be a different color and a different shape (e.g., an arrow, a cross, a circle). The pointer can be used either in pointing mode or in drawing mode. Various basic geometric shapes can be drawn, such as simple lines of varying width, color and opacity, and circles, squares, and rectangles with or without color fill. Also, the pointer can be used to produce textual annotations, provided via keyboard input, to overlay on the high-resolution computer video.

Mousinq Mode

In mousing mode the LLPMD allows any remote collaboration location to have control of the keyboard and mouse of the computer providing the high-resolution image that is being viewed during the remote collaboration session. One could just send the mouse and keyboard commands from the remote location to the computer hosting the collaboration session as is done when the IPKMD is used. However, there is delay introduced when people are collaborating from distant remote locations. The delay, or latency, means that movements of the mouse and inputs of the keyboard are not seen at the remote location until a specific interval of time after they were made. This makes it difficult for a person to control their input into the computer, especially when using the mouse.

The latency arises from two factors. One factor is the actual transmission path. It takes time for the mouse commands to travel from the remote location to the hosting computer. It also takes time for the hosting computer's video to travel back to the remote location. This portion of the total latency depends on distance and the network path that the signals must travel over. But since the signals travel at the speed of light, the latency or delay is fairly small. Given a fairly direct connection path, the latency is on the order of 150 milliseconds from one side of the globe to the other, a little more than 1/10 of a second. Around town the latency is on the order of tens of milliseconds.

The second source of latency or delay results from the compression of the video stream itself. It takes time to compress the high-resolution computer image into a smaller amount of data so that transmitting it does not require as much bandwidth. For a compression ratio of 100⁺-to-1, achieved using an MPEG-2 compression method, the latency is around 350 ms, which is a little more than 1/3 of a second. This may not seem that long, but it is enough delay to make handling the mouse, and pointing to and selecting certain portions of the computer screen (e.g. action buttons and icons) very difficult.

The LLPMD eliminates this second source of latency by allowing the user to see a mouse cursor that is generated and displayed at their local site. Since the “local” cursor is in fact displayed locally, there is no delay. And at the same time the mouse commands are sent to the local LLPMD to generate the movements of the “local” cursor, they are also sent to the computer generating the high-resolution display, which then generates the computer's cursor. The “true” cursor generated by the computer is still seen moving with a delay. However, because the same mouse instructions were sent to both the computer and the local LLPMD the computer's “true” cursor will track the same path, stop at the same location, and send the same mouse-click command(s) as did the “local” cursor generated by the LLPMD.

System Functional Block Diagram

A basic system layout for a typical remote collaboration system configured with the LLPMD is illustrated in FIG. 6-A and FIG. 6-B. There is one LLMPD associated with each remote collaboration location and all of the LLMPDs are identical. The Host Computer 1 is the source of video being viewed by the participants. The video is distributed directly to local users and passed through a high-speed network (this involves MPEG compression/decompression 50) to remote sites. The pointing and mousing commands from the users are passed via a single Internet link to bypass the relatively long delays associated with the MPEG encoding/decoding process.

The operation of the system in pointing mode is described below. It is assumed that all users are viewing the host image at the same resolution (this can be made more flexible but the same resolution simplifies description). Each participant picks a pointer symbol with a unique size, shape and/or color from the LLPMD menu. The size, shape and color of the cursor are used to identify input from each individual participant. The selected pointer will be superimposed on the local display and will move in response to movements of the local LLMPD mouse. The pointer will have two states, “local pointer” and “remote pointer” as controlled by the LLPMD operator. In local mode, the pointer symbol will be displayed at low intensity and the pointer information will not be transmitted to remote locations. When the operator needs to actively point to an object to be viewed at remote sites he or she activates remote pointer mode. The local pointer will change to full intensity and the pointer's characteristics and absolute pointer position, as well as, operator ID information and status information will be transmitted via the Internet to all other sites. LLMPDs will receive pointer information from all other sites that are currently in “remote pointer” mode. The pointer symbols from the sites will be displayed at the specified locations and the pointers will be updated in near real time. An operator will be able to click on a pointer symbol to display operator ID information corresponding to the participant who is associated with the pointer symbol. The net impact of the system is to provide each participant with a pointer that can be easily identified and selectively enabled or disabled.

Mousing mode is an extension of pointing mode. Mousing mode allows any LLMPD mouse to act as the host mouse to control host computer functions. Obviously, only one participant can control the host mouse input at any given time. While any local operator can request control of the host mouse, operators are assigned priority for access to mousing mode. Only the highest priority operator requesting mousing mode is granted access. Once access is granted, the operator's cursor is changed to resemble a standard cursor symbol (e.g, a cross symbol that is colored red). The local mouse can be used in lieu of the host mouse to control host functions. Access is maintained until the currently assigned mouse user relinquishes control. At that point, control reverts to the highest priority user requesting mouse control. Note that mouse control always defaults to the mouse associated with the Host Computer LLMPD if no other sites request mouse control. Messages are displayed from the LLMPDs to indicate who controls the mouse and to identify all users who are requesting access to the mouse at any time. The Host Computer LLMPD can also enable/disable the mousing functions to maintain the security of the host system.

LLMPD Functional Description

The system is modular and can accept up to three Graphics Overlay Boards. Each Graphics Overlay Board can support a single high-resolution video input and provide graphics overlays to indicate pointer, mouse cursor and status information.

A functional block diagram of an LLPMD device with a single Graphics Overlay board is provided in FIG. 6-C. High-resolution video enters the unit via connections on the rear panel. Video loop-through connections and switch selectable Hi-Z or 75-ohm terminations support interconnection of multiple LLPMD devices. The input video is digitized and passed to circuits that are used to provide graphics mixing functions. Graphics information is generated by a graphics generator in response to data received from the local mouse and keyboard and from the Ethernet from other devices to display pointer, mouse and status information. A Graphical User Interface (GUI) is provided for on-screen setup of LLPMD parameters. The GUI may provide a very user-friendly interface and eliminates the need for front-panel controls on the LLPMD, reducing costs and eliminating mounting constraints.

All units with the exception of the designated Host Computer LLPMD operate in an identical manner. The units accept a standard mouse 36, 136 and keyboard 35, 135 to provide a convenient user interface. Pointer symbol and mouse cursor information received via the Ethernet is interpreted by the LLPMD, processed by the Graphics Generator and overlaid upon the incoming video to provide the required operator display.

The Host Computer LLPMD operates somewhat differently as this unit must interact with the Host Computer to control the host mouse and keyboard operations. The insertion of the LLPMD must be transparent to the host computer. Note that in this case, the host mouse and keyboard plug into the Host Computer LLPMD and cables from the LLMPD are passed to the Host. This allows the LLPMD to control the host in mousing mode.

Physical Specifications

To accomplish the above functionality the LLPMD is built with the following specifications. FIG. 6-D shows the front (top) and back (bottom) of the LLPMD. The front is blank since all control and setup functions are provided via a GUI that is overlain on the high-resolution computer imagery.

The back of the LLPMD has two pair of PS/2 connections, two pair of USB serial connections, a 100BaseT Ethernet connection, a serial connection, and connections for RGBHV video.

The two PS/2 Device connections are used to make the physical connection between a PS/2 keyboard and mouse and the device. There are also two USB ports that can be used to plug a USB keyboard and mouse into the device instead of PS/2 devices. Only one type of connectivity or the other can be used for Device input.

Although the LLPMD only needs mouse commands to perform the pointing and mousing functions, the keyboard is attached to the LLPMD nevertheless to provide keyboard input to the GUI for functions such as setting up the LLPMD's menus or setting up character generator functions, such as cursor selection menus, color selection, drawing and annotation, etc.

The two PS/2 and USB Computer connections are used to make the physical connection between the device and the “host” computer being used in the collaboration session. As with the Device connections, only one type of connectivity or the other can be used. When connected to a computer, the Computer PS/2 (and USB) ports will have to provide the correct connectivity signals to indicate to the computer that the keyboard and mouse (USB) ports are active (powered up).

The keyboard and mouse commands provided to the Device inputs are both interpreted locally and sent over the network using the Ethernet connection to all other devices that are being used in a given remote collaboration session.

RS-232 control is provided to allow external control over the LLPMD's various settings. The LLPMD has the ability to display the mouse cursor across as many as three RGB computer inputs at the same time, Monitor1, Monitor2, and Monitor3 (with resolutions up to 2048×1280 each). This is necessary to handle multiple-monitor computer configurations. The base system comes with input for one monitor. Additional inputs can be added by sliding the appropriate card into the back of the device.

Menu Description

The LLPMD has a number of menus used to configure the device. A summary of the menus and their options are given in FIG. 6-E and FIG. 6-F.

### Device Configuration

The Device Configuration Menu allows the IP information, the keyboard and mouse information and the video information of the specific LLPMD to be configured.

### IP Configuration

Each LLPMD has its own IP address. The address can be set via the GUI or the RS-232 port. The following IP options will be set under the IP Configuration Menu:

IP Address (Default 000.000.000.000)

Subnet Mask (Default 255.255.255.255)

Default Gateway (Default 000.000.000.000)

Note that this will be a non-DHCP device, so it will have a fixed IP address.

There is a Reconnect Time option under the IP Configuration Menu. If one of the LLPMD devices cannot be reached (pinged) upon session startup, it will be dropped from the collaboration session. Attempts will be made to connect to the device every Reconnect Time seconds (Default is 120 seconds—2 minutes).

### K/M Configuration

The K/M Configuration Menu will have both an Input mode indicating whether the mouse and keyboard are being input through the PS/2 or USB ports (Default is PS/2). During initialization, all LLPMDs in the remote collaboration session will be polled to ensure that all have the same Input mode specified. If all are not the same, a message will come up indicating which IP addresses do not have the same settings with an option to either Ignore or Retry. Retry will re-query the LLPMDs in the session. Presumably before a Retry someone will have correctly set the LLPMD(s) that were not set up properly. If Ignore is selected, the LLPMD corresponding to the indicated IP address will be permanently dropped from the session (i.e., removed from the Device Connection List).

On the Host Computer LLPMD the Output option under the K/M Configuration Menu will be set to either PS/2 or USB. For devices not connected to the computer, this setting should be NONE (Default).

The K/M Configuration Menu will have an Computer Control Key option which tells the LLPMD which key sequence will act as the signal to take control of the host computer's keyboard and mouse (Default is <esc>C). Upon initialization, the LLPMD that is connected to the host computer will be the one that has keyboard and mouse control. The K/M Configuration Menu will have an Device Control Key option which tells the LLPMD which key sequence will act as the signal to take pass the input of the attached keyboard over to the LLPMD to set up various device and graphics functions/menus (Default is <esc>D). To stop the keyboard from sending commands to the LLPMD for device control the Device Control Key is entered a second time. The Device Control Key acts as a toggle, switching keyboard input from going to the LLPMD versus going through the remote collaboration network. Note that only one specific keyboard and one specific LLPMD will actually be set to pass its keyboard commands to the “Host” computer

### Video Configuration

The Video Configuration Menu will also have the option to set the Number of Heads that are to be used in the remote collaboration session (Default is 1, options are 1, 2 or 3; options 2 and 3 can not be set if enough cards are not present). During initialization, all LLPMDs in the remote collaboration session will be polled to ensure that all have the same number of monitor inputs specified. If all are not the same, a message will come up indicating which IP addresses do not have the same settings with an option to either Ignore or Retry. Retry will re-query the LLPMDs in the session. Presumably before a Retry someone will have correctly set the LLPMD(s) that were not set up properly. If Ignore is selected, the LLPMD corresponding to the indicated IP address will be permanently dropped from the session (i.e., removed from the Device Connection List).

### Device Connection List

To communicate amongst the other LLPMDs in the remote collaboration session, each device will have to know the IP address of all the other devices. Via the Device Connection List Menu the IP addresses of all LLPMD devices being used in the remote collaboration session can be input. Next to the IP address for each device will be an option to Connect the device to the session (when IP address is first entered the Connect Default is YES). The last Connect setting is saved in memory. If Connect is set to NO, that device will not be included in the remote collaboration session.

### Status Menu

A Status Menu will be provided that list the local IPKMD's setup information, The “This Device” Menu will show the status of the specific IPKMD. The “Connected Devices” submenu will show the IP addresses of the other IPKMDs and whether or not they are participating in the remote collaboration session.

Operating Specifications

As discussed above, the computer generates high-resolution video. The RGB output is passed into a matrix switch. The matrix switch delivers the RGB signal to the local LLPMD device, which passes it through to the local display monitor. The matrix switch also delivers the RGB signal to the RGB transmission equipment, which compresses the RGB information and sends it to the two remote locations. At the remote locations the compressed RGB signal is decompressed and passed into the LLPMD at each location, and from there, on to the display monitor at that location. Note that all video signals have the computer's “true” mouse cursor included in the images at all times. As described above, the computer images arrive delayed (as a result of the latency) on the monitors at the remote collaboration locations.

A description of the user interactions, signal flow, and pointing and mousing operations is easiest made by way of an example.

### Pointing Mode

In pointing mode, the LLPMD provides a user at any location the ability to point on the highresolution computer image that is passed via the video 1/0 to the local monitor. For example, a user at location “B” might want to draw attention to a specific detail on the upper left portion of an image. They take the mouse that is connected to the LLPMD and generate a “mouse-action” signal as they move the cursor to the upper-left portion of the screen. Their mouse-action signal is passed from their hand to the LLPMD. At the LLPMD the mouse-action signal is sent in two different directions for processing. In the case that the LLPMD is passing computer control as well, the mouse-action signal will also be sent to the “Host” computer as well.

In one processing path, the mouse-action signal is sent to the character generator (CG) in the LLPMD. The character generator is what overlays the cursor and any drawn geometric objects onto the video being passed through the LLPMD. When the CG receives the mouse commands it moves the cursor in response to those commands. The local user sees their pointer instantaneously move to the upper-left portion of the screen.

The mouse-action signal also passes down a second processing path to the Ethernet connection. In this path, the mouse-action signals are converted from their local format (PS/2 or USB) to IP packets to be sent over the Ethernet. The signal is then sent to all LLPMDs connected during the remote collaboration session.

Just as with a local mouse-action signal, all the LLPMDs also receive all mouse-action signals coming from the various remote LLPMDs. They convert these signals from IP packets back to PS/2 or USB. They are then sent to the CG for processing. The CG identifies which mouse-action signal is coming from which LLPMDs and takes the appropriate action on the cursor assigned to that remote device. So while the user at remote location “B” moved their cursor to the upper-left portion of the video display, the other users at the “Host” location and remote location “C” can move their cursors to the lower right portion of the video display to move them out of the way. All users see all motions almost simultaneously. The only delay involved is the one-way transmission delay of the mouse-action signal from the remote LLPMDs.

As described above, the CG can do other functions such as drawing. By entering the Device Control key from the keyboard attached to the LLPMD a user is able to access various functions of the Character Generator. A menu of those functions is shown in FIG. 6-F. Note that all the device configuration options can be accessed from this on-screen menu as well.

Upon session initialization, all LLPMDs will poll all other LLPMDs to see what the various settings are for their specific Cursor, Drawing and Annotation functions. From there on, whenever a change is made to a setting in a specific LLPMD, the same change will also be set to and made in all other LLPMDs in the remote collaboration session (for the actions coming from that specific LLPMD). This way all LLMPDs are using the same cursors, drawing the same, and annotating the same for a specific user's input.

When multiple high-resolution computer monitors are used, the LLPMD just needs to know that the active pixel area is that of the combined monitors. For example, if three 1280×1024-resolution monitors are being used, the active pixel area is 3×1280 or 3840×1024 pixels.

### Mousing Mode

Mousing mode is not significantly different than pointing mode. To have the pointer's cursor act as the actual computer's cursor is a matter of calibration. The actions of the pointer's cursor have to be calibrated to the actions of the computer's cursor, meaning that at rest, the on-screen cursors representing the two have to be located at the same position on the high-resolution computer output. That way, when the pointer's cursor is moved from one position to another on the high-resolution computer output, the cursor from the computer will start and end at those same locations. For example, moving from pixel location (1159,900) to pixel location (100,121) on a display having a resolution of 1280×1024.

The mouse is a device that sends information regarding “relative motion” to move the computer's cursor (e.g., move up two pixels and left five pixels). Therefore, calibrating the pointer's cursor to the computer's cursor is simply a matter of setting the location of the two to the same spot on the screen. Once this is achieved, the motions of the LLMPD's cursor and the computer's cursor can be kept in sync.

### Computer Control and Mouse Calibration Procedure

To get the pointer's cursor and the computer's cursor calibrated (i.e., moving to the same locations) is a matter of getting their “hot spots” (usually a cursor's “hot spot” is located at its upper left corner or at the center of the cursor) to align. Calibration is achieved as follows.

1) A Collaborator who wants to take control over the computer enters a request for Computer Control.

2) The local LLPDM immediately performs the following actions:

i) It sets a bit in the outgoing status indicating that a request for computer control is pending.

ii) If no one currently has control and no higher priority participant is requesting control the Host Computer LLPDM grants the control request and disable inputs from the host keyboard and mouse.

iii) The Host LLPDM indicates that the designated user has control by sending the status information onto the Ethernet. It changes its own Computer Control setting to YES.

iv) It displays a pop-up on the high-resolution computer output indicating that Calibration of the Pointer to the Mouse is Required.

3) The collaborator then moves the “hot spot” of their pointer's cursor on top of the “hot spot” of the computer's cursor and clicks the left mouse button. Recall that the computer's cursor is frozen as all input is locked out from step 2). The cursors are now aligned.

4) The Host-Computer LLPMD then passes all keyboard and mouse positions through to the “Host” computer, giving the collaborator control of the computer.

### Low-Latency Mouse Control and Behavior

Once the pointer's cursor and the computer's cursor are calibrated, then the collaborator can use the pointer's cursor (which responds immediately) to control the computer. The computer's cursor will still be delayed at the remote sites, but its response will duplicate that of the pointer's cursor.

The current implementation of the Low-Latency Mouse works with the underlying assumption that the computer image is static during the time that the mouse is being moved and mouse commands are being given. If the underlying computer image is moving while the mouse is moving, there will be a loss of calibration to the moving image, since it still would have the latency due to the image compression and transmission from the “Host” computer to the remote collaboration location. Therefore, if one were trying to pick a specific point on a simulation of an airplane flying from left to right across the screen, the point picked using the Low-Latency mouse would actually end up too far to the left on the plane (e.g., the wings might end up picked instead of the cockpit). Note that if the Low-Latency mouse were not used, the error would be even greater. The error in picking location results from the latency of the moving computer image. However, most computer applications do not have objects in motion upon which specific points, or times during their motion, need to be picked. The need to stay calibrated to a moving computer image can be handled to some degree by incorporating object-based, video tracking capabilities into the LLPMD device.

When multiple high-resolution computer monitors are used, the LLPMD just needs to know that its active pixel area is that of the combined monitors. For example, if three 1280×1024 resolution monitors are being used, the active pixel area is 3×1280 or 3840×1024 pixels.

The LLPMD also needs to know whether the “Host” computer has the ability to “wrap” the computer cursor (e.g., when the cursor moves off the left edge it reappears on the right edge), or if it keeps the cursor in a fixed space (e.g., when the cursor is moved to the left edge of the screen area, addition actions to move the cursor farther to the left only result in keeping the cursor located at the left edge of the area). This option is set in the Cursor Configuration Menu as the Edge Option, FIG. 6-F.

The Edge Option should always be set to the way the “Host” computer behaves. That way the LLPMDs cursors will behave the same as the computer's cursor, whether the LLPMD is in pointing or mousing mode. Upon initialization of the Remote Collaboration Session, all LLPMDs should be polled as to the setting of this option, and all should be set the same.

If the Edge Option is not set correctly, the two cursors will loose calibration if an attempt is made to move the cursor beyond the display area. If that happens, the LLPMD has to first be set to the correct Edge Option mode, and the calibration procedure described above has to be repeated (by entering the Computer Control keyboard sequence).

### A Hand-Held Laser-Based Pointing Device

Another pointing device that can be used to aid in collaboration is shown in FIG. 7-A. The hand-held, wireless pointer incorporates an NTSC(PAL) camera, a laser pointer, and a microphone. The device can be pointed at a video screen, a drawing, or any other 2D or 3D object(s) in the room. The laser is used to precisely identify the feature that is being pointed to, and the camera is used to pick up the image surrounding the pointed-to feature. The device allows the NTSC(PAL) camera to zoom in or out around the laser spot, thus providing detailed viewing or the overall relationships of the item being pointed to with its surroundings. The device incorporates a microphone such that the voice of the person doing the pointing can be easily and clearly picked up and transmitted to the other collaborative sites (as well as amplified and heard in the local collaboration room).

Another embodiment of the device indicated in FIG. 7-A would be to incorporate two NTSC(PAL) cameras. The separation of the two cameras in the device, and the appropriate combination of the dual images on a viewing device, would provide a 3D image/perspective of what is being pointed at, but would require the transmission and combination of the two separate camera views.

Audio/Visual Capability

A principal capability of the invention is the transmission of computer-generated screen images. However, to allow full collaboration, that capability is preferably supplemented with audio/visual (AN) capabilities. These capabilities may be integrated into the system design and allow collaborators to see and talk with each other as they work with the computer imagery.

To allow remote collaborators to see each other, cameras at both locations would be used. The number of cameras used depends on the needs of the collaborators. In FIG. 4-F, two cameras (80, 81) at the local site 12 and two cameras 180, 187 at the “remote” site are shown. One camera at each site is used to provide a room-wide view, and the second camera can be used for close-ups of people speaking, or to display maps, models, or other physical devices, media, etc.

Cameras (80, 81) at the local site 12 are connected to video codecs, which can be contained within the ATM switch (60). The video codecs are used to compress the NTSC(PAL) video coming from the cameras to use less bandwidth for transmission to the remote site(s). The encoded NTSC(PAL) camera information is sent over the telecommunications network and is received at the remote site via a video codec at the remote site, which can be contained within the ATM switch (160). There the NTSC(PAL) video signals are decoded, decompressed, and sent to the video monitor at the remote site (90).

Conversely, cameras (180, 181) at the remote site 90 are connected to video codecs, which may be contained within the ATM switch (160). The encoded NTSC(PAL) camera information is sent over the telecommunications network, and is received at the local site 12 via the video codec at the remote site 90, which can be contained within the ATM switch (60). There the NTSC(PAL) video signals are decoded, decompressed, and sent to the video monitor at the remote site (90).

It is important to realize, that in the embodiment of the invention described herein, the NTSC(PAL) video transmission is full motion, not the blocky, jumpy, motion normally associated with current Internet-based teleconferencing. As such, collaboration can occur using the video channels almost as naturally as if the people were in the same room. The ability to provide full-motion, quality video has been validated through testing.

Besides seeing one another, another component of collaboration is being able to speak to one another. This requires the transmission of voice and other audio information. Referring to FIG. 4-G, the sounds from someone speaking at the local site are picked up by the microphone (70). They may then be passed through an echo-canceling device, component (75), and then into the audio codec for compression, which can be in the ATM switch (60). From there, they are transmitted over the telecommunications network, and are received by the audio codes at the remote site for decompression, which can be in the ATM switch (160). From there, they are sent to the speakers (171L, 171R) at the remote site 90.

The reciprocal path is from the microphone (170) at the remote site 90, through the echo canceller (175), into the audio codec (160), over the telecommunications line to the audio codec (60), and to the speakers (components 71L, 71R) at the local site 12.

In the case of multiple collaboration sites, video and audio, just like the high-definition computer imagery, is broadcast to all sites.

Miscellaneous Methods to Increase Collaborative Effectiveness

The NTSC(PAL) video does not need to be transmitted and viewed on separate monitors. Using scan converters (210) and multimedia encoders (211) the NTSC(PAL) video can be manipulated as needed.

For example, four separate camera views can be composited onto one screen such as is done in the case of security systems. The normal method of compositing a number of cameras onto a single screen however results in a decrease of resolution in each individual image (by putting four NTSC video images onto one NTSC screen). Using the technologies described, the separate NTSC video images can be composited and overlain onto the HDTV screen, thus preserving a higher resolution for each image. Keeping sufficient video resolution is critical to effective collaboration, since losses in resolution can result in a distortion of the information being sent. For example, the nuances of facial expressions that indicate a person's emotional state, or the fine detail in a map or drawing, which is transmitted by pointing the video camera at the object.

Another option is to composite the camera images onto the computer image as an overlay. Similar to the way current televisions allow picture-in-picture viewing. This alleviates the need for separate video channels, as the video is composited into and sent along with the computer imagery.

To provide a record of the collaborative session, video tape decks can be included into the system. An analog HDTV recorder (90) can be connected to the output of the RGB-to-analog-HDTV converter (50), or a digital record (not shown) can be connected to the output of the analog-to-digital converter (51). NTSC(PAL) VCR tape decks can also be connected to the NTSC(PAL) video. The NTSC(PAL) video from both locations (sourced from the local site and sourced from the remote site) is available at either location, so a VCR tape deck can be added at one or either of the locations.

Control Systems

There are obviously a large number of components in the collaboration system. To make the system user friendly and provide ergonomic effectiveness the various settings for the variety of components making up the system are handled through a central control system, (20), FIG. 4-H. External control of just about every component of the system is provided by digital interfaces into the various components. In this way, the various pieces of equipment can be configured for different collaborative applications via control system software that provides a touch-panel interface to the users (32, 132).

Preprogrammed configurations can be designed into the control system. Environmental factors can also be controlled such as lighting, window shading, sound sources (e.g., conferencing, radio, etc), volume levels, security, privacy modes (mute), etc. Control over the NTSC(PAL) cameras, compositing of camera images, HDTV tape-based recording, etc can also be controlled through the central control system (20).

“Higher-level” equipment component settings that the typical collaborator should not have access to can be guarded via password-only access in the control system. The control system 20 serves as the human interface to the collaborative hardware components.

Security

In the case that the computer imagery and other components of the collaborative session need to be guarded from someone else “looking in,” encryption can be added to the data streams before they are sent over the telecommunications networks. 128-bit or higher encryption would provide a high level of security. Providing this level of security would involve adding a piece of decryption/encryption hardware (not shown) at each location.

Security can also be added via the broadband provider, dedicated point-to-point communication paths, the use of private virtual networks (VPNs) etc, and passwords and codes in the control systems 20.

Multiple Sites

In the embodiment of the invention described so far, one “local” location and one “remote” location has been discussed. The “local” location has been the one where the source of the computer imagery was coming from (i.e., the computers), and the “remote” location has been the one where off-site collaborators were located. It is important to note though, that the invention is easily scalable to a number of “remote” locations.

To scale the system to a number of “remote” locations requires placing the “remotelocation” hardware components as shown in FIG. 1 at each site (a remote site does not need to have any computer devices). The communications network and/or bandwidth provider can then use a “broadcast” mode such that all “local” signals are transmitted to each “remote” location. Similarly, all “remote” signals would be transmitted to and be interpreted at the “local” facility. The use of command sequences and control systems would manage who has what level of activity at each site.

Any given “local” site can have sufficient hardware to be configured as a “remote” site as well. Therefore such a “two-way” site can both send and receive high-resolution computer imagery. If two or more “two-way” sites are in the collaboration session, then with the appropriate control software, imagery generated from the computer hardware at each “twoway” site can be simultaneously presented to all sites. Because the computer imagery from a number of “two-way” sites can effectively be integrated using the remote-collaboration solution described, computer facilities from a variety of locations can work together to provide a solution to a single problem or task.

A “remote” site also need not be a fixed location. The necessary equipment to collaborate at the “remote” site can easily be placed into a vehicle (plane, train, boat, automobile, truck, tank, etc.). As long as sufficient bandwidth is available, the “remote” site can be moved around to any location, or even be in motion during the session.

Other Factors

The data can be transmitted via any media such as cable, radio, microwave, laser, optical cable, and the like. The media is not really relevant nor is how or the format in which the data is transmitted. For most cases, the data will be transmitted over multimode fiber. The main concern in transmission is sufficient bandwidth and minimal latency (the time for the signals to travel from one site to the other). In the case of latency, it may not be desirable to use satellite transmission, depending on the application, since the time it takes for a signal to leave the earth, travel to the satellite, and bounce back to the earth may be too long for the required mouse capability. Signals going down land-based fiber do not have to travel as great a distance as if they were sent via satellite.

The actual media of transmission is a concern of the bandwidth provider and does not impact the technology either (other than a certain amount of bandwidth be supplied with a preferably minimal latency). For one example, a high-definition TV signal using one level of compression needs about 12 Mbits/s of bandwidth. The compressed NTSC(PAL) video needs less (1.5 to 10 Mbits/s depending on compression). The keyboard, mouse and any other serial devices need even less (0.019 Mbits/s). To send two high-definition images corresponding to two computer monitors, about four to six NTSC(PAL) video sources, the audio, keyboard, mouse and other serial information requires a DS-3 connection, which is 45 Mbits/s (and it would still have room to spare). As technology advances, and different compression schemes are developed, the necessary bandwidth can go down. In the implementation of the present invention any compression scheme can be used.

Video transmission formats are not limiting to the present invention. Any format is acceptable, as long as the broadband provider accepts it. The bandwidth provider basically sets formats. The equipment just has to be able to get the digital signals into that format.

In one embodiment, all signals go over the same connection using a virtual private network VPN. However, that does not need to be the case. The signals can be sent over separate, individual data lines, or can be multiplexed together and sent over the same line.

In an application where the HDTV was brought to the home via a cable company or television broadcast station(s), there would need to be additional separate connections (e.g., a modem connection) to send the keyboard and mouse signals (for example, via the Ethernet).

The present invention describes the connectivity of the mouse and keyboard at both ends. The signals are two-way (standard PS/2 data signals). However, the present invention would provide for any form of keyboard and mouse connectivity (e.g., serial, PS/2, USB, etc.).

With respect to a complex environment created at the local location, i.e., the technology used to provide stereo 3D at the remote location, such technology is not important. Any special environment, simulation, theater, or the like such as a stereo 3D environment can be supported by the technology. For instance, the only thing required for stereo 3D environment is that the source provides dual images of a “scene” from different “viewing angles.” If not already provided as such, these dual image signals could be separated so each would travel through its own path of reformatting, compression, transmission, decompression and viewing. The separated stereo signals could then optionally be combined at the remote location (depending on the method of stereo 3D viewing being used).

Any high-end multidimensional imagery can be handled by the present invention in that each channel used to generate that imagery could have its own separate path. It will be understood that different compression schemes may be devised to send the multi-channel imagery since the image from one viewing angle is related a corresponding image from a different viewing angle. But mixing up the separate images too much may decrease the effective three-dimension nature of the final viewed image.

Since the transport mechanism of the computer imagery is via industry standard broadcast HDTV (high-definition television), collaboration can occur at any number of “normal” commercial broadcast end sites, such as someone's living room. The low-bandwidth mouse, keyboard, pointing-device information can be sent back to the “local” site via modem or through an Internet connection. The HDTV computer imagery is displayed on an HDTV using an attached HDTV MPEG decoder. Such an implementation has lucrative consumer appeal, as things like interactive high-definition animation, virtual-reality and other high-end computer-graphics-based gaming and entertainment, training, etc. can be simultaneously provided to a number of home users.

Other Embodiments and Applications

While the invention has been described in terms of particular embodiments, it is understood that the concepts of the invention may be implemented in many other ways and for many other purposes than that described. Moreover, various electronic instruments may be combined and specially modified for more effective and reduced costs. In one embodiment of the invention, a preferred element will accept computer RGB video of any scan and resolution and transform the signal for the desired scan and resolution and format for replacement of elements 50, 51.

In another embodiment, entertainment, programs, or other viewable images may be generated and broadcast in HDTV format from a computer in real-time as compared to prior art methods of utilizing a recorded playback of a previously recorded program.

In another embodiment, the present invention provides means for local-remote interactivity even with a plurality of remote locations and one or more transmitter locations. For instance, with interactive computer-based entertainment, rather than having a user or subscriber play games on TV by downloading them into a game player over the cable as in the prior art, the user(s) could, according to the present invention, play games directly on the TV with interaction to a transmitting computer at the originating location which generates video/sound images and broadcasts them via HDTV broadcast network. For instance, a mouse/keyboard/joystick or other input device could be linked back to the provider by some suitable means (note these are all-serial devices and could be connected via modem, two-way cable, Internet, or other means). The provider could have the game playing or other interactive-media-producing hardware, which might be a supercomputer, and software for the supercomputer, at the transmitting facility.

As another example, interactive entertainment could be provided in accord with the present invention wherein the viewer takes part in the program. For example, playing contests on TV, or playing a part in some kind of movie wherein the viewer or viewers make decisions about what a character or characters do next, etc. This could involve pre-recorded or real-time outcomes/consequences.

Interactive home schooling, long-distance college courses, medical training, engineering instruction, or any other training wherein students could interact with a teacher and also with computer-based training capabilities without the need for the signal generating computer and/or software at the students location. Governmental applications could also be provided such as voting, virtually appearing before Congress, the House, the courthouse, trial depositions, or other Agency interviews, or for reasons such as getting tax assistance or other help.

The invention can be used to provide Remote Collaboration capabilities with computers as well in a number of different industries and settings as the following examples illustrate.

In the energy industry, workers on offshore rigs can better understand the location of a well bore by visualizing the well bore in real-time while drilling is occurring with its associated 3D seismic data which is kept onshore and visualized using high-end graphics computers. While exploration prospects are being evaluated on seismic data, remote collaboration capabilities that include full computer interaction allow experienced off-site interpreters to be brought in and out of the interpretation process without having to travel around the globe. Instead, Remote Collaboration sessions with computers can be used to gain immediate access to key personnel wherever they are.

In the medical industry advanced visualization methods are used to allow surgeons to plan, and practice detailed surgical operations. These methods require the use of high-end graphics computing resources that use large dataset comprising of various imaging information (examples include CAT-scan imagery, NMR imagery, etc.). Using Remote Collaboration technologies, with computers visualization analysts located with the visualization hardware can interact with surgeons in the operating room. Additionally, other surgeons can be brought into the surgery using the same remote collaboration technology. Therefore, they can see the actual surgery as well as the imagery, and provide real-time advice as an operation is underway.

In the sciences, astronomers in a number of locations can simultaneously view and interact with each other and with real-time and recorded imagery from telescopes and satellites from any number of remote locations. Atmospheric and oceanographic information can be modeled in separate locations and be viewed together by a number of experts during a Remote Collaboration session with computers so they can derive integrated weather and sea-state predictions.

In business and government, high-definition video can be used for high-level negotiating where it is necessary to see the facial nuances of participants to convey effective understanding and communication. This can be achieved using the Remote Collaboration technology described herein, in an embodiment where the source of the high-definition imagery is the output of an HDTV video camera.

In the area of defense, field personnel can have access to high-resolution satellite and other surveillance imagery. Military leaders and planners can see high-resolution images of a battlefield taken by unmanned aerial vehicles (UAVs). That imagery can be sent back to the operations base for real-time review, analysis and decision-making. Flight and other simulations can actually be provided remotely using the described technology. This way, a pilot who is actually on operational duty can get sortie-specific training from simulations generated by high-end computers located at a distant logistical/training base that sends the simulation imagery to the remote operating theater.

In the manufacturing industry, various manufacturers handling different pieces of a larger project can all collaborate together using CAD models and other simulations of the product(s) being made without ever leaving their offices or traveling. Using computer-imagery of the models during Remote Collaboration sessions, each manufacturer can be sure that their component of the overall product will appropriately integrate and operate with all other components.

The present invention can also be combined with prior art or future interactive and/or collaborative techniques to enhance and improve those functions. Thus, the present invention provides for applications and uses that are not presently available and which may be effectively achievable only through the principles, systems, methods and techniques described herein. Therefore, the present invention is not limited to the specific embodiments described in this specification but also includes any embodiments in accord with the spirit of the invention.

What is claimed is:

1. A method for remote collaboration with at least one remote location over a broadband network, comprising the steps of:
a. Generating computer video output;
b. Transmitting the video information over the broadband network to a location remote from the generator;
c. Displaying that video imagery on a monitor at the location;
d. Converting keyboard and mouse commands to a digital format;
e. Transmitting the keyboard and mouse commands over a network;
f. Converting the keyboard and mouse commands back to a format compatible to the computer; and
g. Sending those keyboard and mouse commands into the computer that generates video output.

2. The method of claim 1, wherein the video output is analog RGB and there is further included the step of converting the analog RGB video output to serial digital format.

3. The method of claim 2, wherein said step of converting the analog RGB video output is to serial digital high-definition television (HDTV) format.

4. The method of claim 3, wherein there is further included the step of compressing the serial digital output.

5. The method of claim 3, wherein the step of displaying the video imagery is a display of a video imagery on an HDTV-compatible monitor.

6. The method of claim 2, wherein there is further included the step of compressing the series digital output.

7. The method of claim 6, wherein there is further included the step of decompressing the output.

8. The method of claim 7, wherein said step of decompressing is a step of decompressing the serial digital output.

9. The method of claim 7, wherein there is included the step of converting the decompressed signals into analog RGB computer video.

10. The method of claim 1, wherein step (d) includes converting PS/2 keyboard and mouse commands.

11. The method of claim 10, wherein step (f) includes converting the keyboard and mouse commands back to PS/2 format.

12. The method of claim 10, wherein there are multiple mouse instruments and there is included in step (f) the step of monitoring the mouse commands.

13. The method of claim 1, wherein step (a) includes generating multiple computer video output.

14. The method of claim 13, wherein step (a) includes generating stereo computer analog RGB video output.

15. The method of claim 1, wherein step (a) includes generating digital HDTV signals directly from the computer.

16. The method of claim 1, wherein digital HDTV signals generated are compressed directly from the computer.

17. The method of claim 1, wherein step (a) includes generating NTSC(PAL) video signals.

18. The method of claim 1, wherein step (a) includes generating high-definition, HDTV, camera video signals.

19. The method of claim 1, wherein step (a) includes generating voice and sound signals.

20. The method of claim 1, wherein step (a) includes generating video marking.

21. The method of claim 1, wherein step (a) includes generating signals from multiple computers and step (b) includes the step of selecting and using a variety of computers by a matrix switching system.

22. The method of claim 1, wherein there are multiple remote locations and step (b) includes transmitting multiple switching signals through locations simultaneously using multi-point broadcast networking.

23. The method of claim 22, wherein step (b) includes the step of transmitting substantially simultaneously to the multiple locations.

24. The method of claim 23, wherein step (b) further includes using multi-point broadcast networking.

25. The method of claim 1, wherein the remote location is mobile.

26. The method of claim 1, wherein step (a) includes generating multi-color output.

27. The method of claim 1, wherein step (a) includes video response to mouse movements to be overlain on the computer imagery.

28. The method of claim 1, wherein step (e) includes the step of overlaying the computer imagery with video response to mouse movements.

29. The method of claim 28, wherein step (d) includes the step of delivering the keyboard and mouse commands for display in step (c).

30. The method of claim 1, wherein step (a) includes generating imagery by computer at multiple locations.

31. The method of claim 1, wherein step (a) generates analog RGB computer output that is at least 1280 by 1024.

32. The method of claim 1, wherein there is included the step of compressing the video output by a MPEG-4 video compression method.

33. The method of claim 1, wherein there is included the step of converting the output of step (a) to serial digital high-definition television format, wherein said format is SMPTE-274M 1920×1080i.

34. The method of claim 1, wherein there is included the step of converting pointing signals for transmission over the network.

35. The method of claim 34, wherein the conversion of pointing includes the generation of pointing through NTSC(PAL) video for viewing.

36. The method of claim 34, wherein the conversion of pointing includes the generation of pointing through laser pointing.

37. The method of claim 1, wherein step (e) includes transmitting microphone signals for voice transmission.

38. The method of claim 34, wherein there are multiple pointing sources.

39. The method of claim 38, wherein the multiple sources provide for stereo pointing.

40. The method of claim 1, wherein there are video sources at various locations, at least one of said sources in step (a) including the step of compositing the various images into one high-definition signal and there is further included the step of compressing the signal and step (c) includes displaying the composited imagery.

41. A communication system operable for supporting collaboration between a first location and a second location, the locations being remote from each other comprising:
a. At least one computer at the first location, said computer producing a computer video signal;
b. At least one computer monitor at the first location for displaying said computer video signal;
c. Video converter circuitry at the first location for converting said computer video signal to a high-definition TV digital signal;
d. A data link for transmitting said high-definition TV digital signal to the second location; and
e. A high-definition TV monitor at the second location for displaying said high-definition TV digital signal at the second location.

42. The communication system of claim 41, further comprising:
A video router at the first location for routing said video signal to said computer monitor at the first location and the video converter circuitry at the first location.

43. The communication system of claim 41, wherein said data link has sufficient bandwidth for transmitting said high-definition TV digital signal to the second location such that full motion, full-resolution viewing is provided simultaneously at said computer monitor at the first location and said monitor at the second location.

44. The communication system of claim 41, wherein said high-definition TV digital signal has a resolution of at least 640 by 480.

45. The communication system of claim 44, wherein said high-definition TV digital signal would be above 1280 by 1024.

46. The communication system of claim 41, further comprising:
At least one keyboard at the second location and at least one mouse input device at the second location, said monitor at the second location, said keyboard at the second location, and said mouse input at the second location connecting through the data link directly to the computer at said first location.

47. The communication system of claim 41, further comprising:
a. At least one keyboard at the first location interconnected with said computer for inputting keyboard signals to said first computer;
b. Keyboard converter circuitry at the first location; and
c. At least one keyboard at the second location in communication with said keyboard converter circuitry through said data link for inputting keyboard signals to said computer at the first location.

48. The communication system of claim 47, further comprising:
A keyboard selector for selecting which of said keyboard at the first location and the second location will control keyboard input to the computer at said first location.

49. The communication system of claim 48, wherein one of said keyboards at the first location has priority over all other keyboards.

50. The communication system of claim 48, further comprising:
A keyboard signal router in communication with said keyboards at the first location and the second location.

51. The communication system of claim 41, further comprising:
a. At least one mouse input device at the first location interconnected with the computer for inputting mouse signals to the first computer;
b. Mouse converter circuitry at the first location; and
c. At least one mouse input device at the second location in communication with said mouse converter circuitry through said data link for inputting mouse signals to said computer at the first location.

52. The communication system of claim 51, further comprising:
A mouse selector for selecting which of said one or more mouse input devices at the first location and said one or more mouse input devices at the second location will control mouse input to said computer at the first location.

53. The communication system of claim 51, wherein one of said mouse input devices at the first location has priority over all other mouse input devices.

54. The communication system of claim 51, further comprising:
A mouse signal router in communication with said mouse input devices at the first location and the second location.

55. The communication system of claim 51, wherein said mouse at the second location has an output directly displayed on said high-definition TV digital signal at the second location.

56. A communication method operable for enhancing collaboration between a first location and a second location remote from the first location, comprising:
a. Utilizing a computer at the first location for producing a computer video signal at the first location;
b. Converting said computer video signal to a TV compatible digital signal;
c. Transmitting said TV compatible digital signal to a second location; and
d. Providing controls at the first location and the second location for controlling the computer at the first location.

57. The communication method of claim 56, comprising:
Displaying said TV compatible digital signal with a high-definition TV monitor at the second location.

58. The communication method of claim 56, further comprising providing sufficient bandwidth for said transmitting to permit simultaneous real-time, full motion viewing at the first location and second location.

59. The communication method of claim 56, further comprising:
Providing capability for converting a plurality of scanning rates for said computer video into a selected scanning rate.

60. The communication method of claim 56, further comprising:
a. Providing capability for video communication operable for displaying video pictures of persons at the first location and the second location; and
b. Providing voice communication between the first location and the second location.

61. The communication method of claim 56, further comprising:
Providing a plurality of video displays at the first location from the second location.

62. A communication system operable for supporting collaboration between a first location and a second location remote from the first location, comprising:
A data link;
A computer video signal;
A converter circuitry connected to said data link and said video signal for receiving said computer video signal and converting said computer video signal to a high-definition TV signal suitable for transmission over said data link to the second location.

63. The system of claim 62, wherein there is included said computer video signal has one of a plurality of scanning rates, said high-definition TV signal having a resolution of at least 640 by 480, said high-definition TV signal being operable for displaying full motion video, said converter circuitry being operable for interconnecting a keyboard signal and a mouse signal from said keyboard and said mouse at the second location to a computer at the first location.

64. The system of claim 63, wherein the resolution is at least 1280 by 1024.

65. The system of claim 62, wherein said computer video signal is generated from a mobile location.

66. The system of claim 65, wherein the computer video signal originates from a camera.

67. The system of claim 65, wherein the computer video signal originates from a laser pointer.

68. The method of claim 1, wherein there is included the step of compressing the video output by a MPED-7 video compression method.

69. The system of claim 62, wherein the second location is a mobile location, said location includes a transmitter for transmitting a video signal from the second location to the first location.

70. The system of claim 69, wherein the mobile location includes a transmitter for transmitting an audio signal from the second location to the first location.

71. A method for remotely viewing a 3D environment, comprising:
a. Utilizing a computer for producing the 3D environment at a local location by producing two or more images;
b. Converting each of said two or more images to a television format;
c. Compressing said two or more images in said television format to produce two or more compressed images;
d. Transmitting said two or more compressed images;
e. Decompressing said two or more compressed images at a remote location; and
f. Recombining said images on one or more high-definition TV compatible monitors.

72. A method for collaboration between a first location and second location remote to the first location, comprising:
a. Generating a video output at the first location with a computer located at the first location;
b. Displaying said video output at the first location;
c. Converting said video output to a high-definition television format;
d. Compressing said high-definition television format to produce a compressed signal;
e. Transmitting said compressed signal;
f. Decompressing said compressed signal at the second location to produce a decompressed television video; and
g. Displaying said decompressed television video.

73. The method of claim 72, further comprising:
Providing a video marking device at the first location for marking said video output and said decompressed television video for viewing at the first and second location.

74. The method of claim 72, further comprising:
Providing a video marking device at the second location for marking said video output and said decompressed television video for viewing at the first location and the second location.

75. The method of claim 72, further comprising:
Producing a plurality of video views at the first location for viewing at the second location.

76. The method of claim 72, further comprising:
Producing a plurality of video views at the second location for viewing at the first location.

77. The method of claim 72, further comprising:
Encrypting said compressed signal.

78. The method of claim 72, further comprising:
Providing a plurality of control interfaces at the first location and the second location for configuring aspects including one or more of a group including lighting, window shading, sound sources, volume levels, security, privacy modes, caver images, and recording.

79. A method for real-time communication to at least one remote location, comprising:
a. Utilizing a computer for generating a real-time video output;
b. Producing said real-time video output in a high-definition television format output;
c. Compressing said high-definition television output to produce a compressed high-definition television format output.;
d. Transmitting said compressed high-definition television format output to at least one remote location; and
e. Decompressing said compressed high-definition television format output for viewing at the remote location.

80. A method of claim 79, wherein there are a plurality of remote locations and step (d) includes the step of transmitting said compressed high-definition television format output to a plurality of remote locations; wherein step (e) includes decompressing said compressed high-definition television format for viewing at the plurality of remote locations.

81. A method for communication between a first and a second and third locations remote from the first location, further comprising:
a. Utilizing a computer at the first location for generating a video output;
b. Producing said video output in a high-definition television format output;
c. Compressing said high-definition television format output to produce a compressed HDTV output;
d. Transmitting said compressed HDTV output to the two remote locations;
e. Decompressing said compressed HDTV output for viewing at each of the remote locations; and
f. Interacting with said computer at the first location from at least one of said remote locations.

82. A method for collaboration between a first location and second location remote to the first location, comprising:
a. Generating a video output at the first location with a computer located at the first location;
b. Displaying said video output at the first location;
c. Converting said video to a digital format;
d. Compressing said digital video to produce a compressed signal;
e. Transmitting said compressed signal;
f. Decompressing said compressed signal at the second location to produce a decompressed digital video signal;
g. Converting said decompressed digital video signal to an analog video signal; and
h. Displaying said decompressed television video.
